(19) United States
(12) Patent Application Publication
(10) Pub. No.: US 2013/0021416 A1
(43) Pub. Date: Jan. 24, 2013

(54) LIQUID CIRCULATION SYSTEM

(71) Applicants: Seiichi Yokoyama, Tomi-city (JP); Tomomi Igawa, Tomi-city (JP)

(72) Inventors: Seiichi Yokoyama, Tomi-city (JP); Tomomi Igawa, Tomi-city (JP)

(21) Appl. No.: 13/511,023

(22) PCT Filed: Nov. 26, 2010
(86) PCT No.: PCT/JP2010/071183

§ 371 Date: Oct. 11, 2012

(30) Foreign Application Priority Data
Nov. 27, 2009 (JP) 2009-270294

(51) Int. Cl. B41J 2/175

(52) U.S. Cl. 347/85

(57) ABSTRACT

Liquid is appropriately circulated with a low cost and thereby precipitation of fine particles in the liquid is prevented and bubbles in the liquid flow passage are removed.

A liquid circulation system includes an inkjet head 2 in which a common ink flow passage 16 is formed, an ink cartridge 3, a supply flow passage 4 through which ink is supplied from the ink cartridge 3 to an inlet 16a of the common ink flow passage 16, a return flow passage 5 through which the ink is returned from the outlet 16b of the common ink flow passage 16 to the ink cartridge 3, a tube pump 6 sending the ink in the supply flow passage 4, a tube pump 7 sending the ink in the return flow passage 5, a pressurization bellows unit 8 pressurizing the ink in the supply flow passage 4, a pressure reduction bellows unit 9 depressurizing the ink in the return flow passage 5, a pressurization regulator maintaining the inlet 16a at a center value “+α” of a designated head value, and a pressure reducing regulator 11 maintaining the outlet 16b at a center value “−α” of the designated head value.

### TECHNICAL FIELD

The present invention relates to a liquid circulation system which is mounted on a droplet ejection device.

### BACKGROUND ART

Commonly, in a large-scale inkjet printer, ink is supplied to an inkjet head from an ink cartridge which is detachably mounted. Some of the inks such as metallic ink, pearl ink, white ink and the like, contain fine particles (pigment or the like) whose specific gravity is different from liquid component. The specific gravity of the fine particle which is contained in the ink is large in comparison with that of the liquid component and the fine particle is, for example, structured of metal or ore.

When the ink is left to stand for a long time under an environment that ink flow is stopped, fine particles whose specific gravity is large are precipitated down in the liquid and, as a result, clogging of piping and failure of ejection may be occurred.

Further, a cross-sectional area and a volume of piping are changed due to installation of a joint or a sub tank based on arranging layout of piping and functions of an inkjet printer. In these portions, stagnation of ink may occur when a used amount of the ink is small and, as a result, the fine particles are precipitated to cause a malfunction of the printer and thus a desired printed object is not obtained.

Further, in the inkjet printer, at the time of introducing ink or the like, bubbles stagnated in the middle of piping or in a common ink flow passage of the head are carried to a nozzle together with the ink, which may cause a failure of ejection.

A method circulating ink may be used in order to solve the problem. For precipitation, ink is always moved through circulation of the ink and thus precipitation is prevented by agitating action by the flow. Further, for the bubble, the stagnated bubbles are flowed to a bubble trap or an ink reservoir tank to eliminate the bubbles.

The circulation provides the above-mentioned merits but attention should be given to a pressure control. A pressure at a nozzle portion in the inkjet head gives a large effect to the ejection and thus an ink pressure at the nozzle portion is controlled at a fixed negative pressure and thereby a meniscus in a predetermined shape is formed in the nozzle.

Therefore, conventionally, ink is circulated while adjusting the pressure so as not to affect the meniscus formed in each nozzle (see, for example, Patent Literature 1).

### CITATION LIST

### Patent Literature

[PTL 1] Japanese Patent Laid-Open No. 2006-088564

### SUMMARY OF INVENTION

### Technical Problem

As described in the background art, in an inkjet printer, in order to optimize a shape and a flight trajectory of an ink droplet ejected from each nozzle of the inkjet head, a water head value (pressure) of ink in the inkjet head is adjusted or the like and the ink supplied to each nozzle is formed in a predetermined shaped meniscus.

However, in the conventional liquid circulation system, many pressure sensors for measuring a pressure of an ink flow passage or many complicated pressure adjustment devices are used and thus the system is expensive.

in view of the problem described above, an objective of the present invention is to provide a liquid circulation system in which liquid is appropriately circulated at a low cost without using an expensive pressure sensor while the number of part items is reduced and which is capable of preventing precipitation of fine particles in the liquid and removing bubbles in the liquid flow passage.

### Solution to Problem

A liquid circulation system in accordance with the present invention is a system which is mounted on a droplet ejection device from which droplets are ejected, and the liquid circulation system includes a droplet ejection head which is formed with a common flow passage communicated with a plurality of nozzles from which the droplets are ejected, a liquid filling container which is filled with liquid that is supplied to the droplet ejection head, a first flow passage through which the liquid is supplied from the liquid filling container to one end part of the common flow passage, a second flow passage through which the liquid is returned from the other end part of the common flow passage to the liquid filling container, a differential pressure generating means structured to pressurize the liquid on one end part side in the common flow passage and depressurize the liquid on the other end part side in the common flow passage, and a pressurization regulator which is disposed between the differential pressure generating means and the one end part of the common flow passage and is structured to maintain the liquid at the one end part in the common flow passage at a first pressure.

According to the liquid circulation system in accordance with the present invention, liquid is supplied from a liquid filling container to one end part of the common flow passage of the droplet ejection head through a first flow passage and the liquid is returned from the other end part of the common flow passage to the liquid filling container through the second flow passage. Therefore, the liquid which is filled in the liquid filling container can be circulated through the liquid flow passage passing through the liquid filling container, the first flow passage, the common flow passage and the second flow passage. Further, the differential pressure generating part pressurizes the liquid on one end part side in the common flow passage and depressurizes the liquid on the other end part side in the common flow passage and thereby a differential pressure is generated between both end parts of the common flow passage. Therefore, the ink can be circulated through the ink flow passage passing through the liquid filling container, the first flow passage, the common flow passage and the second flow passage and thus composition such as fine particles contained in the liquid can be agitated and sedimentation and precipitation of the composition such as the fine particles are restrained and bubbles are discharged. Further, since the pressurization regulator is provided between the differential pressure generating means and the one end part of the common flow passage, even when a pressure generated by the differential pressure generating means is varied, the liquid at the one end part in the common flow passage can be maintained at a predetermined first pressure.

In this case, it is preferable that the pressurization regulator shuts off the flow of the liquid when a liquid pressure at the one end part in the common flow passage becomes higher than the first pressure and flows the liquid when the liquid pressure at the one end part in the common flow passage becomes lower than the first pressure. According to this structure, a pressure of the liquid at the one end part in the common flow passage is prevented from becoming lower than the first pressure and the liquid at the one end part in the common flow passage is maintained at the first pressure.

Further, it is preferable that the liquid circulation system is further provided with a pressure reducing regulator which is disposed between the differential pressure generating means and the other end part of the common flow passage and is structured to maintain the liquid at the other end part in the common flow passage at a second pressure that is lower than the first pressure. In a case that the pressure reducing regulator is provided between the differential pressure generating means and the other end part of the common flow passage as described above, even when a liquid pressure depressurized by the differential pressure generating means at the other end part of the common flow passage is varied, the liquid at the other end part in the common flow passage can be maintained at a predetermined second pressure.

In this case, it is preferable that the pressure reducing regulator shuts off the flow of the liquid when a liquid pressure at the other end part in the common flow passage becomes lower than the second pressure and flows the liquid when the liquid pressure at the other end part in the common flow passage becomes higher than the second pressure. According to this structure, a pressure of the liquid at the other end part in the common flow passage is prevented from becoming higher than the second pressure and the liquid at the other end part in the common flow passage is maintained at the second pressure. Further, since the pressurization regulator and the pressure reducing regulator are used, even when a differential pressure generating means which is unable to adjust a pressure with a high degree of accuracy is adopted, variation of the pressure applied to the both end parts of the common flow passage is restrained and thus the liquid can be circulated while the meniscus in the nozzle is maintained appropriately. In addition, the differential pressure generating means is not required to use an expensive member such as a pressure sensor and a complicated control and the pressurization regulator and the pressure reducing regulator are simply and easily structured and thus the cost of the liquid circulation system can be reduced.

In this case, it is preferable that the pressurization regulator is provided with a first pressure chamber into which the liquid is flowed from the liquid filling container through a pressurization side of a differential pressure generating part, a second pressure chamber which is formed with a through hole so as to be communicated with the first pressure chamber and from which the liquid is sent to the one end part of the common flow passage, a diaphragm which separates the second pressure chamber from ambient atmosphere, a valve element which is connected with the diaphragm for opening and closing the through hole, and a pressure control spring which urges the valve element in a direction for closing the through hole. According to this structure, a pressure of the second pressure chamber communicated with the one end part of the common flow passage is normally a negative pressure and thus the diaphragm is drawn to the second pressure chamber side by the outside under atmospheric pressure and a force in a direction for opening the valve element is generated. In this case, when a force which is applied to the diaphragm by the liquid pressure of the second pressure chamber which presses the valve element in an open direction becomes smaller than a force of the pressure control spring which presses the valve element in a close direction, the valve element closes the through hole and supply of the liquid is stopped. Further, when the force which is applied to the diaphragm by the liquid pressure of the second pressure chamber which presses the valve element in the open direction becomes larger than the force of the pressure control spring which presses the valve element in the close direction, the valve element opens the through hole and the supply of the liquid is started again. In this manner, passing and stop of the liquid can be mechanically performed without a complicated control and thus the liquid pressure at the one end part of the common flow passage can be maintained at the set pressure.

Further, it may be structured that air which is adjusted at a predetermined pressure is introduced into the pressurization regulator and the pressurization regulator opens and closes the liquid flow passage based on comparison of the pressure of the air with a liquid pressure which is discharged to the one end part of the common flow passage. In this case, supply and stop of the liquid is switched based on a pressure difference between the liquid which is discharged to the one end part of the common flow passage and the air having a predetermined set pressure. Therefore, the liquid pressure at the one end part of the common flow passage can be easily changed by changing the set pressure of the air and thus the degree of freedom of the set pressure is remarkably improved and, even when a plurality of the pressurization regulators is used, the set pressure can be changed simultaneously.

In this case, it is preferable that the pressurization regulator is provided with a first pressure chamber into which the liquid is flowed from the liquid filling container, a second pressure chamber which is formed with a through hole so as to be communicated with the first pressure chamber and from which the liquid is discharged to the one end part of the common flow passage, a third pressure chamber into which air at a predetermined pressure is flowed, a diaphragm which separates the second pressure chamber from the third pressure chamber, and a valve element which is connected with the diaphragm for opening and closing the through hole. According to this structure, when a liquid pressure discharged from the second pressure chamber becomes higher than the pressure of the air which is flowed into the third pressure chamber, the valve element closes the through hole and the supply of the liquid is stopped and, when the liquid pressure discharged from the second pressure chamber becomes lower than the pressure of the air which is flowed into the third pressure chamber, the valve element opens the through hole and the supply of the liquid is started again. Therefore, passing and stop of the liquid can be mechanically performed by setting the pressure of the air which is flowed into the third pressure chamber without performing complicated control and thus the liquid pressure at the one end part of the common flow passage can be further surely maintained at the set pressure.

Further, in the case described above, it is preferable that the pressure reducing regulator is provided with a first pressure chamber into which the liquid returned from the other end part of the common flow passage is flowed, a second pressure chamber which is formed with a through hole so as to be communicated with the first pressure chamber and from which the liquid is discharged to a flow passage communicated with a negative pressure side of the differential pressure generating part, a diaphragm which separates the first pressure chamber from ambient atmosphere, a valve element which is connected with the diaphragm for opening and closing the through hole, and a pressure control spring which urges the valve element in a direction for opening the through hole. According to this structure, a pressure of the first pressure chamber communicated with the other end part of the common flow passage is normally a negative pressure and thus the diaphragm is drawn to the first pressure chamber side by the outside under an atmospheric pressure and a force in a direction for closing the valve element is generated. In this case, when a force of the pressure control spring which presses the valve element in an open direction becomes smaller than a force which is applied to the diaphragm by the liquid pressure of the first pressure chamber which presses the valve element in a close direction, the valve element closes the through hole and supply of the liquid is stopped. Further, when the force of the pressure control spring which presses the valve element in the open direction becomes larger than the force which is applied to the diaphragm by the liquid pressure of the first pressure chamber which presses the valve element in the close direction, the valve element opens the through hole and the supply of the liquid is started again. In this manner, passing and stop of the liquid can be mechanically performed without a complicated control and thus the liquid pressure at the other end part of the common flow passage can be maintained at the set pressure.

Further, it may be structured that air which is adjusted at a predetermined pressure is introduced into the pressure reducing regulator and the pressure reducing regulator opens and closes a liquid flow passage based on comparison of the pressure of the air with a liquid pressure which is flowed from the other end part of the common flow passage. In this case, supply and stop of the liquid is switched based on a pressure difference between the liquid which is flowed from the other end part of the common flow passage and the air having a predetermined set pressure. Therefore, the liquid pressure at the other end part of the common flow passage can be easily changed by changing the set pressure of the air and thus the degree of freedom of the set pressure is remarkably improved and, even when a plurality of the pressure reducing regulators is used, the set pressure can be changed simultaneously.

In this case, it is preferable that the pressure reducing regulator is provided with a first pressure chamber into which the liquid is flowed from the other end part of the common flow passage, a second pressure chamber which is formed with a through hole so as to be communicated with the first pressure chamber and from which the liquid is discharged to the liquid filling container, a third pressure chamber into which air at a predetermined pressure is flowed, a diaphragm which separates the second pressure chamber from the third pressure chamber, and a valve element which is connected with the diaphragm for opening and closing the through hole. According to this structure, when a liquid pressure flowed into the first pressure chamber becomes lower than a pressure of the air which is flowed into the third pressure chamber, the valve element closes the through hole and the supply of the liquid is stopped and, when the liquid pressure flowed into the first pressure chamber becomes higher than the pressure of the air which is flowed into the third pressure chamber, the valve element opens the through hole and the supply of the liquid is started again. Therefore, passing and stop of the liquid can be mechanically performed by setting the pressure of the air which is flowed into the third pressure chamber without performing complicated control and thus the liquid pressure at the other end part of the common flow passage can be further surely maintained at the set pressure.

Further, it is preferable that the first pressure and the second pressure are set to be within a range of a designated water head of the droplet ejection head, and the first pressure is a pressure higher by a predetermined pressure than the center value of the designated head value of the droplet ejection head and the second pressure is a pressure lower by a predetermined pressure than a center value of the designated head value. When a pressure generated by the pressurization regulator at the one end part of the common flow passage and a pressure generated by the pressure reducing regulator at the other end part of the common flow passage are set to be values interposing the center value of the designated head value as described above, an average pressure of the common flow passage can be brought close to the center value of the designated head value and thus the meniscus of the liquid formed in each nozzle of the droplet ejection head can be prevented from being broken.

Further, it may be structured that the differential pressure generating means pressurizes the liquid on the one end part side in the common flow passage by using a pressurization bellows for pressurizing the liquid and a first tube pump for sending the liquid to a liquid droplet ejection head side, and the differential pressure generating means depressurizes the liquid on the other end part side in the common flow passage by using a pressure reduction bellows for depressurizing the liquid and a second tube pump for sending the liquid to a liquid filling container side. According to this structure, a predetermined differential pressure is generated between both end parts of the common flow passage with a simple structure, i.e., a bellows and a tube pump and thus the cost can be further reduced.

Further, the differential pressure generating means may be provided with a differential pressure generating pump which is provided in the first flow passage or the second flow passage for generating a differential pressure. A predetermined differential pressure may be also generated between both end parts of the common flow passage by providing a differential pressure generating pump in the first flow passage or the second flow passage as described above.

Further, it may be structured that the differential pressure generating means pressurizes the liquid on the one end part side in the common flow passage by using a pressurization bellows for pressurizing the liquid and a first tube pump for sending the liquid to a droplet ejection head side and a height difference is provided between the droplet ejection head and the liquid filling container so that a liquid pressure at the other end part in the common flow passage is lower than the liquid pressure at the one end part in the common flow passage. A differential pressure may be also generated between both end parts of the common flow passage by providing the pressurization bellows, the first tube pump and the pressurization regulator in the first flow passage and by providing a height difference between the droplet ejection head and the liquid filling container as described above.

### Advantageous Effects of Invention

According to the present invention, the liquid is appropriately circulated at a low cost without using an expensive pressure sensor while the number of part items is reduced and thus precipitation of fine particles in the liquid can be prevented and bubbles in the liquid flow passage can be removed.

### BRIEF DESCRIPTION OF DRAWINGS

FIG. 1 is a schematic structure view showing an ink circulation system in accordance with a first embodiment of the present invention.

FIG. 2 is a schematic cross-sectional view showing an inkjet head.

FIG. 3A and FIG. 3B are views showing a model of a pressurization regulator. FIG. 3A shows a state that a valve is closed and FIG. 3B shows a state that the valve is opened.

FIG. 4A and FIG. 4B are views showing a model of a pressure reducing regulator. FIG. 4A shows a state that a valve is closed and FIG. 4B shows a state that the valve is opened.

FIG. 5 is a schematic structure view showing an ink circulation system in accordance with a second embodiment of the present invention.

FIG. 6 is a schematic structure view showing an ink circulation system in accordance with a third embodiment of the present invention.

FIG. 7 is a schematic structure view showing an ink circulation system in accordance with a fourth embodiment of the present invention.

FIG. 8 is a schematic structure view showing an ink circulation system in accordance with a fifth embodiment of the present invention.

FIG. 9A and FIG. 9B are views showing a model of a pilot air type pressurization regulator. FIG. 9A shows a state that a valve is closed and FIG. 9B shows a state that the valve is opened.

FIG. 10A and FIG. 10B are views showing a model of a pilot air type pressure reducing regulator. FIG. 10A shows a state that a valve is closed and FIG. 10B shows a state that the valve is opened.

### DESCRIPTION OF EMBODIMENTS

Preferred embodiments of a liquid circulation system in accordance with the present invention will be described in detail below with reference to the accompanying drawings. In these embodiments, a liquid circulation system in accordance with the present invention is applied to an ink circulation system mounted on an inkjet printer which is a droplet ejection device. An ink circulation system in accordance with the embodiments is a system in which ink is circulated through an ink flow passage of an inkjet printer. Further, as ink which is circulated in the ink circulation system, for example, metallic ink, pearl ink or white ink is used in which fine particles such as pigment whose specific gravity is different from liquid component are contained. In the following description, the same reference sign is used in the same or corresponding portion.

### First Embodiment

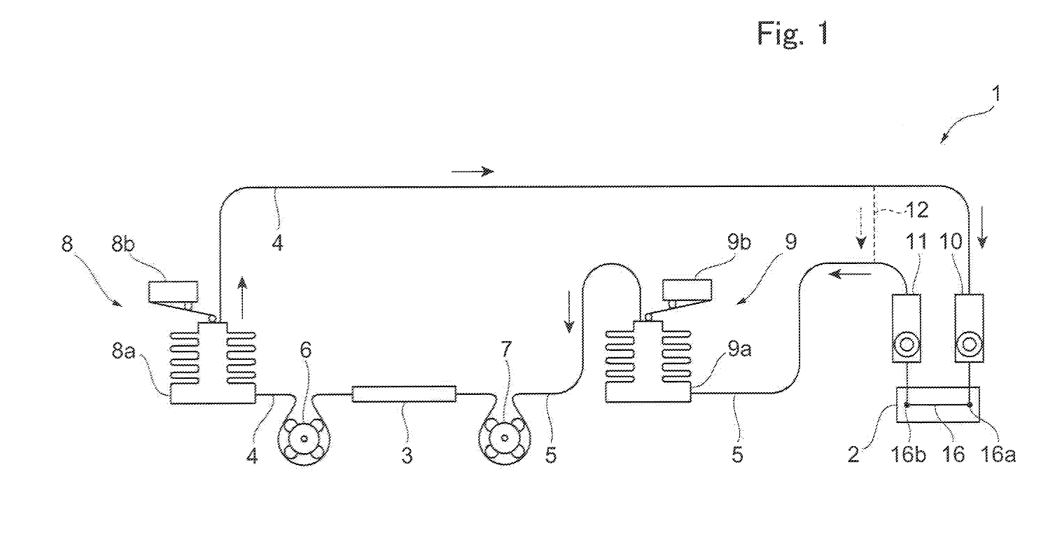

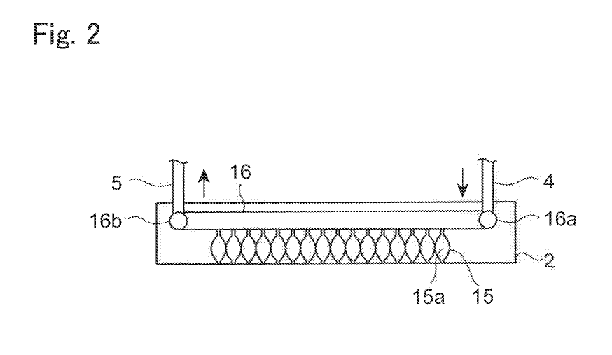

FIG. 1 is a schematic structure view showing an ink circulation system in accordance with a first embodiment of the present invention and FIG. 2 is a schematic cross-sectional view showing an inkjet head. As shown in FIG. 1, an ink circulation system 1 in accordance with a first embodiment of the present invention includes an inkjet head 2, an ink cartridge 3, a supply flow passage 4, a return flow passage 5, a tube pump 6, a tube pump 7, a pressurization bellows unit 8, a pressure reduction bellows unit 9, a pressurization regulator 10, a pressure reducing regulator 11, and a high speed circulating flow passage 12.

The inkjet head 2 is a head for ejecting ink droplets. Therefore, as shown in FIG. 2, the inkjet head 2 is formed with a number of nozzles 15 and a common ink flow passage 16 which is communicated with all the nozzles 15.

The common ink flow passage 16 is a flow passage through which ink supplied from the ink cartridge 3 to the inkjet head 2 is flowed. The common ink flow passage 16 is communicated with all the nozzles 15 which are formed in the inkjet head 2 and the ink supplied to the inkjet head 2 from the ink cartridge 3 is distributed and supplied to the respective nozzles 15. One end of the common ink flow passage 16 is formed with an inlet 16a which introduces the ink supplied from the supply flow passage 4 into the common ink flow passage 16 and the other end of the common ink flow passage 16 is formed with an outlet 16b through which the ink supplied to the common ink flow passage 16 is discharged to the return flow passage 5. The inlet 16a and the outlet 16b are formed at both ends of the common ink flow passage 16. Therefore, the ink introduced through the inlet 16a is flowed from the one end of the common ink flow passage 16 to the other end and is discharged through the outlet 16b.

Each of the nozzles 15 ejects the ink supplied from the common ink flow passage 16 as an ink droplet having a predetermined quantity. Each nozzle 15 is formed in a minute tube-like shape. Each nozzle 15 is formed with a chamber 15a whose diameter partially becomes large so as to be bulged. A piezoelectric element not shown for pressurizing the inside of the chamber 15a is attached in the chamber 15a. When the piezoelectric element is driven to pressurize the inside of the chamber 15a, a predetermined quantity of ink is pushed out from the chamber 15a and an ink droplet having a predetermined size is ejected from a tip end of each nozzle 15. Further, a head value of the ink and the like are adjusted so as to prevent leakage of the ink from each nozzle 15 and the ink supplied to the nozzle 15 is held in a negative pressure state. In addition, in order to optimize a shape and a flight trajectory of an ink droplet ejected from each nozzle 15, the head value of the ink and the like are adjusted to form the ink supplied to each nozzle 15 in a meniscus having a predetermined shape.

The inkjet head 2 structured as described above is mounted on a carriage not shown which is attached so as to be movable in a scan direction. Further, the inkjet head 2 ejects ink droplets when the carriage is moved in the scan direction and thereby an image or the like is printed on a recording medium which is placed on a platen not shown.

The ink cartridge 3 is an ink container filled with ink which is supplied to the inkjet head 2. The ink cartridge 3 is disposed at an arbitrary height irrespective of a designated head value.

The supply flow passage 4 is structured of a long and thin tube-like member (tube), which communicates the ink cartridge 3 with the inkjet head 2 and the ink filled in the ink cartridge 3 is supplied to the inkjet head 2 through the supply flow passage 4. The tube pump 6, the pressurization bellows unit 8 and the pressurization regulator 10 are attached in the supply flow passage 4 between the ink cartridge 3 and the inkjet head 2. Therefore, the supply flow passage 4 is structured of a flow passage which communicates the ink cartridge 3 with the tube pump 6, a flow passage which communicates the tube pump 6 with the pressurization bellows unit 8, a flow passage which communicates the pressurization bellows unit 8 with the pressurization regulator 10, and a flow passage which communicates the pressurization regulator 10 with the inkjet head 2.

The return flow passage 5 is structured of a long and thin tube-like member (tube), which communicates the inkjet head 2 with the ink cartridge 3 and the ink filled in the inkjet head 2 is returned to the ink cartridge 3 through the return flow passage 5. The pressure reducing regulator 11, the pressure reduction bellows unit 9 and the tube pump 7 are attached in the return flow passage 5 between the inkjet head 2 and the ink cartridge 3. Therefore, the return flow passage 5 is structured of a flow passage which communicates the inkjet head 2 with the pressure reducing regulator 11, a flow passage which communicates the pressure reducing regulator 11 with the pressure reduction bellows unit 9, a flow passage which communicates the pressure reduction bellows unit 9 with the tube pump 7, and a flow passage which communicates the tube pump 7 with the ink cartridge 3.

The tube pump 6 is a liquid feeding device which sends the ink in the supply flow passage 4 toward the inkjet head 2. The tube pump 6 is structured of a built-in tube not shown and a built-in roller which is rotated while crushing the tube. The supply flow passage 4 is connected to both ends of the built-in tube. Therefore, the built-in roller is rotated while crushing the built-in tube of the tube pump 6 and thereby the ink supplied to the supply flow passage 4 from the ink cartridge 3 is forcibly sent to the inkjet head 2 side. Further, the tube pump 6 is capable of adjusting a flow rate of the ink flowing through the supply flow passage 4C by adjusting the rotation number of the built-in roller.

The tube pump 7 is a liquid feeding device which sends the ink in the return flow passage 5 toward the ink cartridge 3. The tube pump 7 is structured of a built-in tube not shown and a built-in roller which is rotated while crushing the built-in tube. The return flow passage 5 is connected to both ends of the built-in tube. Therefore, the built-in roller is rotated while crushing the built-in tube of the tube pump 7 and thereby the ink discharged from the common ink flow passage 16 to the return flow passage 5 is forcibly sent to the ink cartridge 3 side. Further, the tube pump 7 is capable of adjusting a flow rate of the ink flowing through the return flow passage 5 by adjusting the rotation number of the built-in roller.

The pressurization bellows unit 8 is structured of a metal bellows 8a structured of a bellows-like expansion and contraction pipe and a micro switch 8b which is provided on an upper side of the metal bellows 8a and whose “ON/OFF” is switched by expansion and contraction of the metal bellows 8a. The pressurization bellows unit 8 is disposed between the tube pump 6 and the pressurization regulator 10. The micro switch 8b is interlocked with the tube pump and, when the metal bellows 8a is expanded, the micro switch 8b becomes an “OFF” position and, when the metal bellows 8a is contracted, the micro switch 8b becomes an “ON” position. The metal bellows 8a is, for example, structured of stainless steel.

In the pressurization bellows unit 8, the metal bellows 8a is expanded by forcibly sending ink into its inside from the tube pump 6. When the metal bellows 8a is expanded to a predetermined length, the micro switch 8b is turned “OFF” and drive of the tube pump 6 is stopped. As a result, the expanded metal bellows 8a is contracted by its restoring force and thus the ink flowing through the supply flow passage 4 is pressurized. When the metal bellows 8a is contracted to a predetermined length, the micro switch 8b is turned “ON” and the drive of the tube pump 6 is started again. In this manner, the ink flowing through the supply flow passage 4 is pressurized by expansion and contraction of the metal bellows 8a. Therefore, the pressurization bellows unit 8 is capable of adjusting a pressure value for pressurizing the ink flowing through the supply flow passage 4 by adjusting a spring constant of the metal bellows 8a. In accordance with an embodiment of the present invention, the pressurization bellows unit 8 pressurizes the ink flowing through the supply flow passage 4, for example, in a range from 5000 to 20000 Pa (≈from 500 to 2000 mm H₂O) by setting the spring constant of the metal bellows 8a.

The pressure reduction bellows unit 9 is structured of a metal bellows 9a structured of a bellows-like expansion and contraction pipe and a micro switch 9b which is provided on an upper side of the metal bellows 9a and whose “ON/OFF” is switched by expansion and contraction of the metal bellows Pa. The pressure reduction bellows unit 9 is disposed between the pressure reducing regulator 11 and the tube pump 7. The micro switch 9b is interlocked with the tube pump and, when the metal bellows 9a is expanded, the micro switch 9b becomes an “ON” position and, when the metal bellows 9a is contracted, the micro switch 9b becomes an “OFF” position. The metal bellows 9a is, for example, structured of stainless steel.

In the pressure reduction bellows unit 9, the metal bellows 9a is contracted by forcibly sucking the ink by the tube pump 7. When the metal bellows 9a is contracted to a predetermined length, the micro switch 9b is turned “OFF” and the drive of the tube pump 7 is stopped. As a result, the contracted metal bellows 8a is expanded by its restoring force and the ink flowing through the return flow passage 5 is depressurized. When the metal bellows 8a is expanded to a predetermined length, the micro switch 9b is turned “ON” and the drive of the tube pump 7 is started again. In this manner, the ink flowing through the return flow passage 5 is depressurized by expansion and contraction of the metal bellows 9a. Therefore, the pressure reduction bellows unit 9 is capable of adjusting a pressure value for depressurizing the ink flowing through the return flow passage 5 by adjusting a spring constant of the metal bellows 9a. In accordance with an embodiment of the present invention, the pressure reduction bellows unit 9 depressurizes the ink flowing through the return flow passage 5, for example, in a range from −5000 to −20000 Pa by setting a spring constant of the metal bellows 9a.

The pressurization regulator 10 is disposed between the pressurization bellows unit 8 and the inkjet head 2 and is a regulator so as to maintain an inlet 16a of the common ink flow passage 16 at a predetermined set pressure or more. The pressurization regulator 10 is also referred to as a pressurization damper.

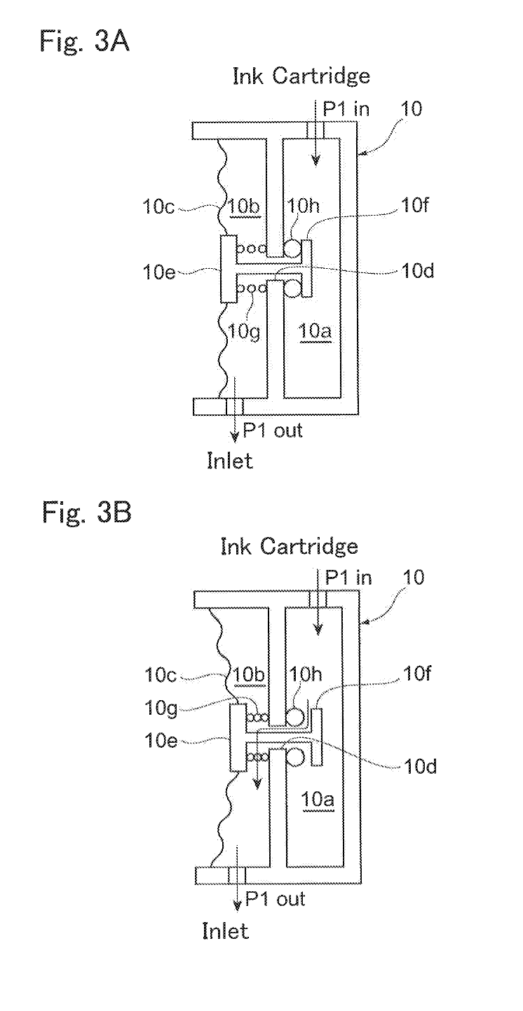

FIG. 3A and FIG. 3B are views showing a model of the pressurization regulator. FIG. 3A shows a state that a valve is closed and FIG. 3B shows a state that the valve is opened. As shown in FIGS. 3A and 3B, the pressurization regulator 10 is formed of a first pressure chamber 10a into which the ink supplied from the ink cartridge 3 is flowed, and a second pressure chamber 10b which is covered by a diaphragm 10c and from which the ink is flowed out to the inlet 16a of the common ink flow passage 16. An outside of the diaphragm 10c covering the second pressure chamber 10b is exposed to the atmospheric pressure. In addition, the pressurization regulator 10 is formed with a through hole 10d which communicates the first pressure chamber 10a with the second pressure chamber 10b to flow the ink from the first pressure chamber 10a to the second pressure chamber 10b. A valve element 10e for opening or closing the through hole 10d is inserted, into the through hole 10d. One end of the valve element 10e is connected with the diaphragm 10c and is movably held by the diaphragm 10c and its other end is formed with a valve 10f for closing the through hole 10d from the first pressure chamber 10a side. In the first pressure chamber 10a, an O-ring 10h for sealing is attached at a position corresponding to the valve 10f. The valve element 10e is urged by a pressure control spring 10g in a direction so that the valve 10f closes the through hole 10d. The pressure control spring 10g is capable of being expanded and contracted by an adjusting screw not shown.

In this embodiment, a pressure of the ink flowing into the first pressure chamber 10a is set to be “P1in”, a pressure of the ink flowing out from the second pressure chamber 10b is set to be “P1out”, an area of the diaphragm 10c is set to be “A1”, and an urging force of the pressure control spring 10g is set to be “F1”. The pressure “P1out” of the ink flowing out from the second pressure chamber 10b is set to be a negative pressure so that a shape of the ink supplied to each nozzle is formed in a predetermined meniscus shape.

Normally, since the pressure “P1out” is a negative pressure, a force obtained by multiplying the “P1out” by the area “A1” is a force acting in a direction for opening the valve element 10e (right direction in FIGS. 3A and 3B). In addition, the urging force “F1” of the pressure control spring 10g is a force acting in a direction for closing the valve element 10e (left direction in FIGS. 3A and 3B).

Therefore, as shown in FIG. 3A, when a force obtained by multiplying the “P1out” acting to open the valve element 10e by the area “A1” becomes not more than the urging force “F1” acting to close the valve element 10e (|F1|≧|P1out×A1|), the valve element 10e is urged to the left side in FIGS. 3A and 3B by the urging force “F1” of the pressure control spring 10g and the through hole 10d is closed by the valve 10f. In this manner, the flow of the ink from the first pressure chamber 10a to the second pressure chamber 10b is shut off and the supply of the ink to the inlet 16a is stopped. In the above-mentioned expression, “| |” is a symbol representing an absolute value.

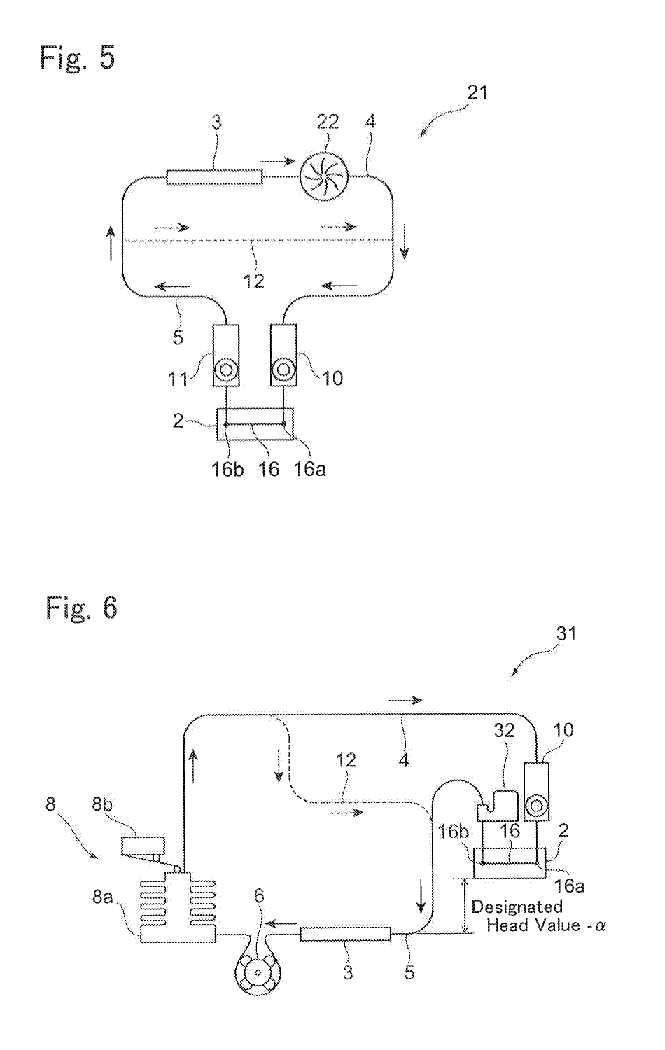

On the other hand, as shown in FIG. 31, when the force obtained by multiplying the “P1out” acting to open the valve element 10e by the area “A1” becomes larger than the urging force “F1” acting to close the valve element 10e (|F1|<|P1out×A1|), the diaphragm 10c is deformed to the right side in FIGS. 5A and 3B against the urging force “F1” of the pressure control spring 10g to open the through hole 10d. As a result, the ink is flowed into the second pressure chamber 10b from the first pressure chamber 10a and supply of the ink to the inlet 16a is started again.

In this case, in order to control the pressure “P1in” in a constant pressure by opening and closing the valve 10f, the pressure “P1in” is required to be not less than the pressure “P1out” and it is preferable that the pressure “P1in” is set to be a sufficiently higher value than the pressure “P1out”.

Strictly, in the pressurization regulator 10, a force obtained by multiplying a pressure of the pressure “P1in” acting on the valve 10f by an area of the valve 10f is also occurred. However, since the area of the valve 10f is normally small, the force may be ignored.

As described above, when an open-and-close operation of the valve 10f is repeated in a state that the pressure “P1in” is not less than the pressure “P1out”, the pressure “P1out” is maintained to be substantially constant although some variation may be occurred. As a result, the pressure “P1out” which is maintained by the pressurization regulator 10 becomes a set pressure of the pressurization regulator 10. The set pressure of the pressurization regulator 10 is determined based on the urging force “F1” of the pressure control spring 100g and the area “A1” of the diaphragm 10c and thus the set pressure of the pressurization regulator 10 is adjusted by adjusting the strength of the pressure control spring 10g.

Then, the set pressure of the pressurization regulator 10 is set to be a center value “+α” (first pressure) of the designated head value by adjusting the strength of the pressure control spring 10g. As a result, the pressure “F1out” of the ink outputted from the second pressure chamber O1b by an open-and-close operation of the valve 10f is maintained at the center value “+α” of the designated head value and thus an ink pressure of the inlet 16a communicated with the second pressure chamber 10b is also maintained at the center value “+α” of designated head value.

The pressure reducing regulator 11 is disposed between the pressure reduction bellows unit 9 and the inkjet head 2 and is a regulator so that an outlet 16b of the common ink flow passage 16 is maintained at a predetermined set pressure or less. The pressure reducing regulator 11 is also referred to as a pressure reducing damper.

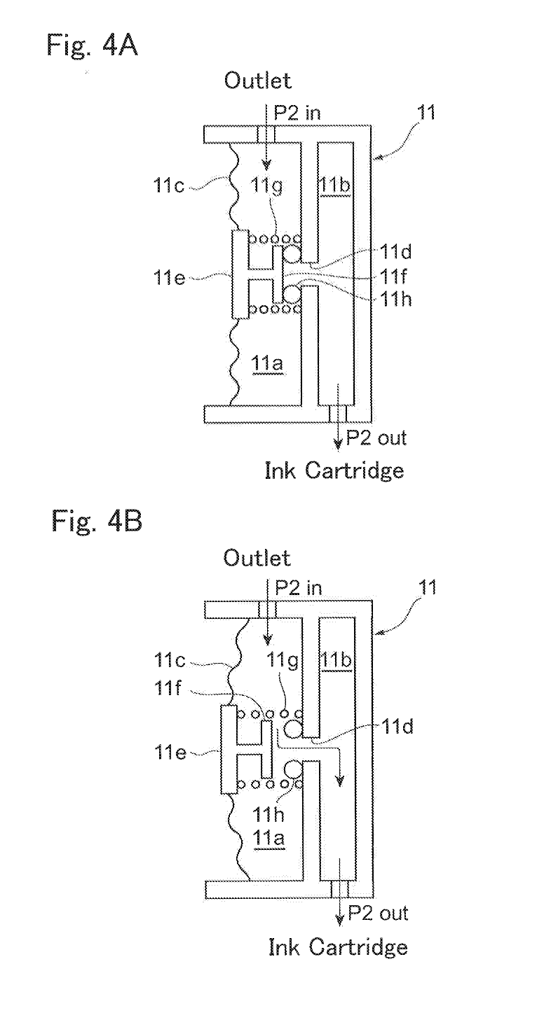

FIG. 4A and FIG. 4B are views showing a model of the pressure reducing regulator. FIG. 14A shows a state that a valve is closed and FIG. 4B shows a state that the valve is opened. As shown in FIGS. 4A and 4B, the pressure reducing regulator 11 is formed of a first pressure chamber 11a which is covered by a diaphragm 11c and into which the ink returned from the outlet 16b of the ink jet head 2 is flowed, and a second pressure chamber 11b from which the ink is flowed out to the ink cartridge 3. An outside of the diaphragm lie covering the first pressure chamber 11a is exposed to the atmospheric pressure. Further, the pressure reducing regulator 11 is formed with a through hole lid which communicates the first pressure chamber 11a with the second pressure chamber 11b so that the ink is flowed to the second pressure chamber 11b from the first pressure chamber 11a, and the pressure reducing regulator 11 is provided with a valve element 11e for opening and closing the through hole 11d. One end of the valve element 11e is connected with the diaphragm 11c and is movably held by the diaphragm 11c and its other end is formed with a valve 11f for closing the through hole 11d from the first pressure chamber 11a side. In the first pressure chamber 11a, an O-ring 11h for sealing is attached at a position corresponding to the valve 11f. The valve element 11e is urged by a pressure control spring 11g in a direction so that the valve 11f opens the through hole 11d. The pressure control spring 11g is capable of being expanded and contracted by an adjusting screw not shown.

In this embodiment, a pressure of the ink flowing into the first pressure chamber 11a is set to be “P2in”, a pressure of the ink flowing out from the second pressure chamber 11b is set to be “P2out”, an area of the diaphragm 11c is set to be “A2”, and an urging force of the pressure control spring 11g is set to be “F2”. The pressure “P2in” of the ink flowing into the first pressure chamber 11a is set to be a negative pressure so that a shape of the ink supplied to each nozzle is formed in a predetermined meniscus shape.

Normally, since the pressure “P2in” is a negative pressure, a force obtained by multiplying the “P2in” by the area “A2” is a force acting in a direction for closing the valve element 11e (right direction in FIGS. 4A and 4B). In addition, the urging force “F2” of the pressure control spring 11g is a force acting in a direction for opening the valve element 11e (left direction in FIGS. 4A and 4B).

Therefore, as shown in FIG. 4A, when a force obtained by multiplying the “P2in” acting to close the valve element 11e by the area “A2” becomes not less than the urging force “F2” acting to open the valve element lie (|F2|≦|P2in×A2|), the valve element 11e is moved to the right side in FIGS. 3A and 3B against the urging force “F2” of the pressure control spring 11g and the through hole 11d is closed by the valve 11f. Therefore, the flow of the ink from the first pressure chamber 11a to the second pressure chamber 11b is shut off and the discharge of the ink from the outlet 16b is stopped.

On the other hand, as shown in FIG. 4B, when the force obtained by multiplying the “P2in” acting to close the valve element 11e by the area “A2” becomes smaller than the urging force “F2” acting to open the valve element lie (|F2|>|P2in×A2|), the valve element 11e is moved to the left side in FIGS. 4A and 4B by the urging force “F2” of the pressure control spring 11g to open the through hole 11d. Therefore, ink is flowed into the second pressure chamber 11b from the first pressure chamber 11a and discharge of the ink from the outlet 16b is started again.

In this case, in order to control the pressure “P2in” at a constant pressure by opening and closing the valve 11f, the pressure “P2out” is required to be not more than the pressure “P2in” and it is preferable that the pressure “P2out” is set to be a sufficiently lower value than the pressure “P2in”.

Strictly, in the pressure reducing regulator 11, a force obtained by multiplying a pressure of the pressure “P2out” acting on the valve 11f by an area of the valve 11f is also occurred. However, since the area of the valve 10f is commonly small, the force may be ignored.

As described above, when an open-and-close operation of the valve 11f is repeated in a state that the pressure “P2out” is not more than the pressure “P2in”, the pressure “P2in” is maintained to be substantially constant although some variation may be occurred. As a result, the pressure “P2in” which is maintained by the pressure reducing regulator 11 becomes a set pressure of the pressure reducing regulator 11. The set pressure of the pressure reducing regulator 11 is determined based on the urging force “F2” of the pressure control spring 11g and the area “A2” of the diaphragm 11c and thus the set pressure of the pressure reducing regulator 11 is adjusted by adjusting the strength of the pressure control spring 11g.

Then, the set pressure of the pressure reducing regulator 11 is set to be a center value “−α” (second pressure) of the designated head value by adjusting the strength of the pressure control spring 11g. As a result, the pressure “P2in” of the ink inputted into the first pressure chamber 11a by an open-and-close operation of the valve 11f is maintained at the center value “−α” of the designated head value and thus an ink pressure of the outlet 16b communicated with the first pressure chamber 11a is also maintained at the center value “−α” of designated head value.

As described above, the set pressure of the pressurization regulator 10 is set to be the center value “+α” of the designated head value and the set pressure of the pressure reducing regulator 11 is set to be the center value “−α” of the designated head value and thereby a differential pressure of “2α” is generated between both end parts of the common ink flow passage 16 of the inkjet head 2.

In this case, it is preferable that the differential pressure “2α” generated by the pressurization regulator 10 and the pressure reducing regulator 11 is set to be a value so that ink is circulated to the extent that fine particles contained in liquid component of the ink are agitated. Further, it is preferable that the differential pressure “2α” is set to be a value within a range of a shape keeping strength of meniscus in which the meniscus shape of the ink formed in each nozzle 15 is not broken.

Therefore, the differential pressure “2α” generated between both end parts of the common ink flow passage 16 by the pressurization regulator 10 and the pressure reducing regulator 11 is, for example, set to be 100 Pa. In this case, the set pressure of the pressurization regulator 10 is the center value +50 Pa of the designated head value and the set pressure of the pressure reducing regulator 11 is the center value −50 Pa of the designated head value.

In addition, the pressurization regulator 10 is required to set the pressure “P1in” of the ink flowing into the first pressure chamber 10a to be not less than the pressure “P1out” of the ink outputted from the second pressure chamber 10b and thus a pressure generated by the pressurization bellows unit 8 is, for example, set to be in a range from 5000 to 20000 Pa. Therefore, the pressure “P1in” of the ink which is flowed into the first pressure chamber 10a becomes in a range from 5000 to 20000 Pa. On the other hand, the pressure reducing regulator 11 is required to set the pressure “P2out” of the ink outputted from the second pressure chamber lib to be not more than the pressure “P2in” of the ink flowed into the first pressure chamber 11a and thus a pressure generated by the pressure reduction bellows unit 9 is, for example, set to be in a range from −5000 to −20000 Pa. Therefore, the pressure “P2out” of the ink which is flowed out from the second pressure chamber 11b becomes in a range from −5000 to −20000 Pa.

As described above, in the pressurization bellows unit 8, a pressure applied to the ink is varied due to hysteresis of the ON/OFF switching of the micro switch 8b. However, as long as the pressure “P1in” of the ink flowed into the first pressure chamber 10a is not less than the pressure “P1out” of the ink outputted from the second pressure chamber 10b, the pressurization regulator 10 maintains the pressure “P1out” of the ink outputted from the second pressure chamber 10b at the center value “+α” of the designated head value. Therefore, even when pressure variation is occurred by the pressurization bellows unit 8, the pressure of the inlet 16a is maintained at the center value “+α” of the designated head value.

Further, in the pressure reduction bellows unit 9, a pressure applied to the ink is varied due to hysteresis of the ON/OFF switching of the micro switch 9b. However, as long as the pressure “P2out” of the ink outputted from the second pressure chamber 11b is not more than the pressure “P2in” of the ink flowed into the first pressure chamber 11a, the pressure reducing regulator 11 maintains the pressure “P2in” of the ink flowed into the first pressure chamber 11a at the center value “−α” of the designated head value. Therefore, even when pressure variation by the pressure reduction bellows unit 9 is occurred, the pressure of the outlet 16b is maintained, at the center value “−α” of the designated head value.

The high speed circulating flow passage 12 is structured of a long and thin tube-like member (tube), by which the inkjet head 2, the pressurization regulator and the pressure reducing regulator 11 are bypassed. The high speed circulating flow passage 12 is a flow passage for forcibly circulating ink at a high speed in an ink flow passage passing through the ink cartridge 3, the tube pump 6, the tube pump 7, the pressurization bellows unit 8 and the pressure reduction bellows unit 9. The high speed circulating flow passage 12 is, similarly to the supply flow passage 4 and the return flow passage 5, structured of a long and thin tube-like member (tube). One end of the high speed circulating flow passage 12 is connected between the pressurization bellows unit 8 and the pressurization regulator 10 in the supply flow passage 4, and the other end of the high speed circulating flow passage 12 is connected between the pressure reduction bellows unit 9 and the pressure reducing regulator 11 in the return flow passage 5.

The high speed circulating flow passage 12 is capable of being opened and closed by an electromagnetic valve not shown. When the high speed circulating flow passage 12 is opened, ink is capable of bypassing the inkjet head 2, the pressurization regulator 10 and the pressure reducing regulator and circulating through the ink flow passage passing through the ink cartridge 3, the tube pump 6, the tube pump 7, the pressurization bellows unit 8 and the pressure reduction bellows unit 9.

Next, an operation of the ink circulation system 1 will be described below. An operation of the ink circulation system 1 includes a normal circulating operation which is performed at a normal time and a high-speed circulating operation and they will be described below successively.

First, a normal circulating operation which is performed at a normal time will be described below. The normal circulating operation is performed by driving the tube pump 6, the tube pump 7, the micro switch 8b of the pressurization bellows unit 8, and the micro switch 9b of the pressure reduction bellows unit 9 through a control section not shown. In the normal circulating operation, the high speed circulating flow passage 12 is closed.

In the normal circulating operation, the ink in the supply flow passage 4 is sent toward the inkjet head 2 by the tube pump 6. Further, the ink which is sent out by the tube pump 6 is pressurized, for example, in a range from 5000 to 20000 Pa by the pressurization bellows unit 8. Therefore, the ink which is filled in the ink cartridge 3 is pressure-fed toward the inlet 16a and the ink on the inlet 16a side of the inkjet head 2 in the supply flow passage 4 is pressurized, for example, in a range from 5000 to 20000 Pa.

In this case, in the pressurization regulator 10, the ink which is pressure-fed by the tube pump 6 and the pressurization bellows unit 8 is flowed into the first pressure chamber 10a. Then, when the pressure “P1out” of the ink which is flowed out from the second pressure chamber 10b to the inlet 16a becomes not more than the center value “+α” of the designated head value, the valve 10f opens the through hole 10d. As a result, the ink flowed into the first pressure chamber 10a is flowed out from the second pressure chamber 10b and supply of the ink to the inlet 16a is performed. On the other hand, the pressure “P1out” of the ink which is flowed out from the second pressure chamber 10b to the inlet 16a becomes higher than the center value “+α” of the designated head value, the valve 10f closes the through hole 10d. As a result, flow of the ink from the first pressure chamber 10a to the second pressure chamber 10b is shut off and the supply of the ink to the inlet 16a is stopped. In this manner, the ink supplied to the inlet 16a is maintained at the center value “+α” of the designated head value, which is the set pressure, by an open-and-close operation of the valve 10f based on the relationship between the pressure “P1out” of the ink flowing out from the second pressure chamber 10b to the inlet 16a and the center value of the designated head value.

On the other hand, the ink in the return flow passage 5 is sent out to the ink cartridge 3 side by the tube pump 7 and the pressure on the outlet 16b side of the inkjet head 2 in the return flow passage 5 is depressurized, for example, in the range from −5000 to −20000 Pa by the pressure reduction bellows unit 9.

In this case, in the pressure reducing regulator 11, the ink is sent out by the tube pump 7 and the pressure reduction bellows unit 9 and thereby the pressure of the second pressure chamber 11b is lowered. Then, when the pressure “P2in” of the ink which is flowed into the first pressure chamber 11a from the outlet 16b becomes not less than the center value “−α” of the designated head value, the valve 11f opens the through hole 11d. Therefore, the ink discharged from the outlet 16b is flowed into the second pressure chamber 11b through the first pressure chamber 11a and is sent out by the tube pump 7 and the pressure reduction bellows unit 9. On the other hand, when the pressure “P2in” of the ink which is flowed into the first pressure chamber 11a from the outlet 16b becomes lower than the center value “−α” of the designated head value, the valve 11f closes the through hole 11d. Therefore, the flow of the ink from the first pressure chamber 11a to the second pressure chamber 11b is shut off and the discharge of the ink from the outlet 16b is stopped. In this manner, the ink returned from the outlet 16b is maintained at the center value “−α” of the designated head value, which is the set pressure, by an open-and-close operation of the valve 11f based on the relationship between the pressure “P2in” of the ink flowing out from the outlet 16b to the first pressure chamber 11a and the center value of the designated head value.

Therefore, ink is flowed through the common ink flow passage 16 from the inlet 16a to the outlet 16b by the differential pressure of “2α” generated between the inlet 16a and the outlet 16b. In this manner, the ink stored in the ink cartridge 3 is circulated through the supply flow passage 4, the tube pump 6, the supply flow passage 4, the pressurization bellows unit 8, the supply flow passage 4, the pressurization regulator 10, the supply flow passage 4, the common ink flow passage 16 of the inkjet head 2, the return flow passage 5, the pressure reducing regulator 11, the return flow passage 5, the pressure reduction bellows unit 9, the return flow passage 5, the tube pump 7, the return flow passage 5 and the ink cartridge 3.

Next, a high-speed circulating operation will be described below. The high-speed circulating operation is an operation by which ink is filled in the ink flow passage or, by which composition such as fine particles contained in the ink is surly agitated. The high-speed circulating operation is performed periodically or at an arbitrary time, for example, when the power of the inkjet printer is turned on or when maintenance is performed. In the high-speed circulating operation, first, an electromagnetic valve for opening and closing the high speed circulating flow passage 12 is driven and controlled to open the high speed circulating flow passage 12. Therefore, since ink is flowed to the high speed circulating flow passage 12, the ink is capable of bypassing the inkjet head 2, the pressurization regulator 10 and the pressure reducing regulator and circulating through the ink flow passage passing through the ink cartridge 3, the tube pump 6, the tube pump 7, the pressurization bellows unit 8 and the pressure reduction bellows unit 9.

Further, similarly to the normal circulating operation, the tube pump 6, the tube pump 7, the micro switch 8b of the pressurization bellows unit 8, and the micro switch 9b of the pressure reduction bellows unit 9 are driven and controlled. In this case, the tube pump 6 and the tube pump 7 are rotated at a higher speed than the normal circulating operation. As a result, ink is circulated at a high speed through the ink flow passage passing through the ink cartridge 3, the tube pump 6, the tube pump 7, the pressurization bellows unit 8 and the pressure reduction bellows unit 9.

In this manner, composition such as fine particles contained in the ink is agitated sufficiently in the ink flow passage passing through the ink cartridge 3, the tube pump 6, the tube pump 7, the pressurization bellows unit 8 and the pressure reduction bellows unit 9 and its sedimentation and precipitation are restrained.

In accordance with an embodiment of the present invention, when the pressure loss of the high speed circulating flow passage 12 is set to be high, since the differential pressure of both ends of the high speed circulating flow passage 12 becomes large, the differential pressure similar to the normal circulating time can be supplied to the pressurization regulator 10 and the pressure reducing regulator 11. In this case, when the high speed circulating flow passage 12 is opened all the time, the bypassed circulating flow passage is strongly agitated all the time and, in addition, the differential pressure at the normal circulating time is applied to the inkjet head 2 side from the high speed circulating flow passage 12 and thus it is suitable for the ink which is further easily precipitated.

As described above, according to the ink circulation system 1 in accordance with the first embodiment, ink is supplied from the ink cartridge 3 to the inlet 16a of the common ink flow passage 16 through the supply flow passage 4 and the ink is returned from the outlet 16b of the common ink flow passage 16 to the ink cartridge 3 through the return flow passage 5. Therefore, the ink which is stored in the ink cartridge 3 can be circulated through the ink flow passage passing through the ink cartridge 3, the supply flow passage 4, the common ink flow passage 16 and the return flow passage 5. Further, the ink on the inkjet head 2 side in the supply flow passage 4 is pressurized by the tube pump 6 and the pressurization bellows unit 8 and the ink on the ink cartridge 3 side in the return flow passage 5 is depressurized by the tube pump 7 and the pressure reduction bellows unit 9 and thereby a differential pressure is generated between both end parts of the common ink flow passage 16. Therefore, the ink can be circulated in the ink flow passage passing through the ink cartridge 3, the supply flow passage 4, the common ink flow passage 16 and the return flow passage 5 and thus composition such as fine particles contained in the ink is agitated and sedimentation and precipitation of the composition such as the fine particles are restrained. Further, air bubbles stagnant in the piping can be flowed to remove appropriately.

In this case, since the pressurization regulator 10 is provided between the pressurization bellows unit 8 and the inlet 16a of the common ink flow passage 16, even when a pressure generated by the tube pump 6 and the pressurization bellows unit 8 is varied, the pressure of the ink of the inlet 16a in the common ink flow passage 16 can be maintained at the center value “−α” of the designated head value. Further, since the pressure reducing regulator 11 is provided between the pressure reduction bellows unit 9 and the outlet 16b of the common ink flow passage 16, even when a pressure generated by the tube pump 7 and the pressure reduction bellows unit 9 is varied, the pressure of the ink of the outlet 16b in the common ink flow passage 16 can be maintained at the center value “−α” of the designated head value.

Further, in the pressurization regulator 10, a pressure of the second pressure chamber 10b communicated with the inlet 16a is normally a negative pressure and thus the diaphragm 10c is drawn to the second pressure chamber 10b side by the outside under atmospheric pressure and a force in a direction for opening the valve element 10e is generated. In this case, when a force applied to the diaphragm 10c by an ink pressure of the second pressure chamber 10b which presses the valve element 10e in an open direction becomes smaller than a force of the pressure control spring 10g which presses the valve element 10e in a close direction, the valve element 10e closes the through hole 10d and supply of the ink is stopped. Further, when the force applied to the diaphragm 10c by the ink pressure of the second pressure chamber 10b which presses the valve element 10e in the open direction becomes larger than the force of the pressure control spring 10g which presses the valve element 10e in the close direction, the valve element 10e opens the through hole 10d and the supply of the ink is started again. In this manner, passing and stop of the ink can be mechanically performed without a complicated control and thus the ink pressure of the inlet lBa can be maintained at the set pressure.

Further, in the pressure reducing regulator 11, a pressure of the first pressure chamber 11a communicated with the outlet 16b is normally a negative pressure and thus the diaphragm 11e is drawn to the first pressure chamber 11a side by the outside under atmospheric pressure and a force in a direction for closing the valve element 11e is generated. In this case, when a force applied to the diaphragm 11c by an ink pressure of the first pressure chamber 11a which presses the valve element 11e in a close direction becomes larger than a force of the pressure control spring 11g which presses the valve element 11e in an open direction, the valve element 11e closes the through hole 11d and supply of the ink is stopped. Further, when the force applied to the diaphragm 11c by the ink pressure of the first pressure chamber 11a which presses the valve element 11e in the close direction becomes smaller than the force of the pressure control spring 11g which presses the valve element 11e in the open direction, the valve element 11e opens the through hole 11d and the supply of the ink is started again. In this manner, passing and stop of the ink can be mechanically performed without a complicated control and thus the ink pressure of the outlet 16b can be maintained at the set pressure.

Further, the set pressure of the pressurization regulator 10 is set to be the center value “+α” of the designated head value and the set pressure of the pressure reducing regulator 11 is set to be the center value “−α” of the designated head value. Therefore, an average pressure of the common ink flow passage 16 can be brought close to the center value of the designated head value and thus the meniscus of the ink formed in each nozzle 15 can be prevented from being broken.

Further, since the tube pump 6 and the pressurization bellows unit 8 are provided in the supply flow passage 4, ink on the inlet 16a side in the common ink flow passage 16 can be pressurized and, since the tube pump 7 and the pressure reduction bellows unit 9 are provided in the return flow passage 5, ink on the outlet 16b side in the common ink flow passage 16 can be depressurized. Therefore, a predetermined differential pressure is generated between both end parts of the common ink flow passage 16 to circulate the ink with a simple structure such as a bellows unit or a tube pump.

Further, when pressures generated in the pressurization bellows unit 8 and the pressure reduction bellows unit 9 are adjusted, a pressure of the center value of the designated head value can be applied to the inkjet head 2 without being restricted by a height position of the ink cartridge 3. Therefore, the ink cartridge 3 can be disposed at an arbitrary height position by using the pressurization bellows unit 8 and the pressure reduction bellows unit 9.

Further, when the ink stored in the ink cartridge 3 is used up, the ink is not supplied to the pressurization bellows unit 8 and thus the micro switch 8b is not switched. Therefore, a state that the ink in the ink cartridge 3 has been used up can be detected by monitoring the switching of the micro switch 8b.

### Second Embodiment

Next, an ink circulation system in accordance with a second embodiment will be described below with reference to FIG. 5. FIG. 5 is a schematic structure view showing an ink circulation system in accordance with the second embodiment of the present invention. As shown in FIG. 5, the ink circulation system 21 in accordance with the second embodiment includes an inkjet head 2, an ink cartridge 3, a supply flow passage 4, a return flow passage 5, a pressurization regulator 10, a pressure reducing regulator 11, a high speed circulating flow passage 12, and a differential pressure generating pump 22.

The differential pressure generating pump 22 is structured of a so-called centrifugal pump, which forcibly sends out ink from an input port to an output port to generate a differential pressure between the input port and the output port. In the differential pressure generating pump 22, the input port into which the ink is inputted is connected with the ink cartridge 3 and the output port from which the ink is outputted is connected with the pressurization regulator 10.

The differential pressure generating pump 22 forcibly sends out ink to the pressurization regulator 10 and thereby the supply flow passage 4 on the pressurization regulator 10 side is pressurized, and ink is sucked from the ink cartridge 3 by the differential pressure generating pump 22 to depressurize the return flow passage 5. In this manner, a differential pressure is generated between an inlet 16a and an outlet 16b of a common ink flow passage 16. Further, a drive force of the differential pressure generating pump 22 is adjusted and thereby a pressure “P1in” of the ink which is pressure-fed into a first pressure chamber 10a of the pressurization regulator 10 is, for example, set in a range from 5000 to 20000 Pa and a pressure “P2out” of the ink which is sucked from a second pressure chamber lib of the pressure reducing regulator 11 is, for example, set in a range from −5000 to −20000 Pa.

Next, an operation of the ink circulation system 21 will be described below. In this embodiment, a high-speed circulating operation is basically similar to the first embodiment and thus only a normal circulating operation will be described below.

In the normal circulating operation, the differential pressure generating pump 22 is driven by a control section not shown.

As a result, ink is sucked from the ink cartridge 3 by the differential pressure generating pump 22 and the sucked ink is forcibly sent out to the pressurization regulator 10. Therefore, the ink on the inlet 16a side of the inkjet head 2 in the supply flow passage 4 is, for example, pressurized in a range from 5000 to 20000 Pa and a pressure on the outlet 16b side of the inkjet head 2 in the return flow passage 5 is, for example, depressurized in a range from −5000 to −20000 Pa.

Further, the ink of the inlet 16a is maintained at a pressure of the center value “+α” of the designated head value by the pressurization regulator 10 and the ink of the outlet 16b is maintained at a pressure of the center value “−α” of the designated head value by the pressure reducing regulator 11.

As a result, a differential pressure of “2α” is generated between the inlet 16a and the outlet 16b and thus the ink is flowed from the inlet 16a to the outlet 16b through the common ink flow passage 16. Therefore, the ink stored in the ink cartridge 3 is circulated through the supply flow passage 4, the differential pressure generating pump 22, the supply flow passage 4, the pressurization regulator 10, the supply flow passage 4, the common ink flow passage 16 of the inkjet head 2, the return flow passage 5 and the ink cartridge 3.

As described above, according to the ink circulation system 21 in accordance with the second embodiment, the following operation-effects are obtained together with the operation-effects of the above-mentioned ink circulation system. In other words, according to the ink circulation system 21 in accordance with the second embodiment, a differential pressure is also generated between both end parts of the common ink flow passage 16 by the differential pressure generating pump 22. Therefore, the ink is circulated in the ink flow passage and thus composition such as fine particles contained in the ink can be agitated and sedimentation and precipitation of the composition such as the fine particles are restrained. Further, air bubbles stagnant in the piping can be flowed to remove appropriately.

In addition, a pressure can be applied to the ink flow passage by the differential pressure generating pump 22 and thus, when the pressure generated by the differential pressure generating pump 22 is adjusted, a pressure of the center value of the designated head value can be applied to the inkjet head 2 without being restricted by a height position of the ink cartridge 3. Therefore, the ink cartridge 3 can be disposed at an arbitrary height position by using the differential pressure generating pump 22.

### Third Embodiment

Next, an ink circulation system in accordance with a third embodiment will be described below with reference to FIG. 6. FIG. 6 is a schematic structure view showing an ink circulation system in accordance with the third embodiment of the present invention. As shown in FIG. 6, an ink circulation system 31 in accordance with the third embodiment includes an inkjet head 2, an ink cartridge 3, a supply flow passage 4, a return flow passage 5, a tube pump 6, a pressurization bellows unit 8, a pressurization regulator 10, a high speed circulating flow passage 12, and a passive regulator 32.

The passive regulator 32 relaxes pressure variation of an outlet 16b in a common ink flow passage 16.

In the third embodiment, a pressure adjusting means comprised of the tube pump 6, the pressurization bellows unit 8 and the pressurization regulator 10 is provided between the inkjet head 2 and the ink cartridge 3 in the supply flow passage 4. Therefore, an inlet 16a of the common ink flow passage 16 can be maintained at the center value “+α” of the designated head value. However, only the passive regulator 32 is provided between the inkjet head 2 and the ink cartridge 3 in the return flow passage 5 and a pressure adjusting means such as a tube pump, a pressure reduction bellows unit and a pressure reducing regulator is not provided in the return flow passage 5. Therefore, in the ink circulation system 31, a relative height of the ink cartridge to the inkjet head 2 is set so that the head value of the inkjet head 2 becomes the center value “−α” of the designated head value. In this manner, the outlet 16b of the common ink flow passage 16 is maintained at the center value “−α” of the designated head value.

Next, an operation of the ink circulation system 31 will be described below. A high-speed circulating operation is basically similar to the first embodiment and thus only a normal circulating operation will be described below.

In the normal circulating operation, the tube pump 6 and a micro switch 8b of the pressurization bellows unit 8 are driven by a control section not shown. In the normal circulating operation, the high speed circulating flow passage 12 is closed.

In the normal circulating operation, ink in the supply flow passage 4 is sent to the inkjet head 2 side by the tube pump 6 and ink of the inlet 16a side of the inkjet head 2 in the supply flow passage 4 is pressurized, for example, in a range from 5000 to 20000 Pa by the pressurization bellows unit 8. Further, the ink of the inlet 16a is maintained at a pressure of the center value “+α” of the designated head value by the pressurization regulator 10.

On the other hand, the inkjet head 2 and the ink cartridge 3 are disposed so that a height difference between the inkjet head 2 and the ink cartridge 3 is set to be the center value “−α” of the designated head value and thus the ink of the outlet 16b is maintained at a pressure of the center value “−α” of the designated head value.

Therefore, a differential pressure of “2α” is generated between the inlet 16a and the outlet 16b and thus ink is flowed from the inlet 16a to the outlet 16b through the common ink flow passage 16. As a result, ink stored in the ink cartridge 3 is circulated through the supply flow passage 4, the tube pump 6, the supply flow passage 4, the pressurization bellows unit 8, the supply flow passage 4, the pressurization regulator 10, the supply flow passage 4, the common ink flow passage 16 of the inkjet head 2, the return flow passage 5, the passive regulator 32, the return flow passage 5 and the ink cartridge 3.

As described above, according to the ink circulation system 31 in accordance with the third embodiment, the following operation-effects are obtained in addition to the operation-effects of the above-mentioned ink circulation systems. In other words, according to the ink circulation system 31 in accordance with the third embodiment, since the ink cartridge 3 is disposed at a lower position with respect to the inkjet head 2, ink on the outlet 16b side in the return flow passage is depressurized and thus a differential pressure is generated between both end parts of the common ink flow passage 16. Therefore, the ink can be circulated through the ink flow passage.

In addition, the ink cartridge 3 is disposed so that a pressure of the ink on the inkjet head 2 side in the return flow passage 5 becomes not more than the center value “−α” of the designated head value and thus the pressure of the ink in the outlet 16b can be maintained at the center value “−α” of the designated head value by the pressure reducing regulator 11. Therefore, an average pressure of the common ink flow passage 16 can be brought close to the center value of the designated head value and thus the meniscus of the ink formed in each nozzle 15 of the inkjet head 2 can be prevented from being broken.

### Fourth Embodiment

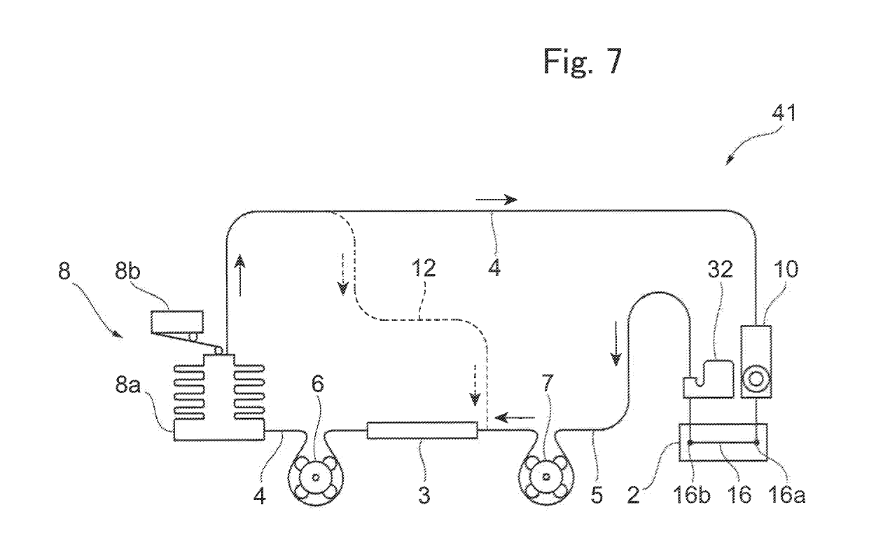

Next, an ink circulation system in accordance with a fourth embodiment will be described below with reference to FIG. 7. FIG. 7 is a schematic structure view showing an ink circulation system in accordance with the fourth embodiment of the present invention. As shown in FIG. 7, an ink circulation system 41 in accordance with the fourth embodiment includes an inkjet head 2, an ink cartridge 3, a supply flow passage 4, a return flow passage 5, a tube pump 6, a tube pump 7, a pressurization bellows unit 8, a pressurization regulator 10, a high speed circulating flow passage 12 and a passive regulator 32.

In other words, in the ink circulation system 41, the pressure reduction bellows unit 9 of the ink circulation system 1 in accordance with the first embodiment is not used and a passive regulator 32 is provided instead of the pressure reducing regulator 11.

Next, an operation of the ink circulation system 41 will be described below. A high-speed circulating operation is basically similar to the first embodiment and thus only a normal circulating operation will be described below.

In the normal circulating operation, the tube pump 6, the tube pump 7, the micro switch 8b of the pressurization bellows unit 8 are driven by a control section not shown. In the normal circulating operation, the high speed circulating flow passage 12 is closed.

In the normal circulating operation, ink in the supply flow passage 4 is sent toward the inkjet head 2 side by the tube pump 6 and ink on the inlet 16a side of the inkjet head 2 in the supply flow passage 4 is pressurized, for example, in a range from 5000 to 20000 Pa by the pressurization bellows unit 8. Further, the ink of the inlet 16a is maintained at a pressure of the center value “+α” of the designated head value by the pressurization regulator 10.

On the other hand, ink in the return flow passage 5 is sent out toward the ink cartridge 3 by the tube pump 7. In this case, in the common ink flow passage 16, a pressure loss is occurred in the ink flowing through the common ink flow passage 16 and thus a differential pressure due to the pressure loss is generated. Therefore, a drive force of the tube pump 7 is adjusted and thereby a pressure of the center value “−α” of the designated head value is generated in the outlet 16b. In order to maintain the pressure of the outlet 16b at the center value “−α” of the designated head value, the flow rate of the ink by the tube pump 7 is maintained to be constant.

As described above, ink is flowed from the inlet 16a to the outlet 16b through the common ink flow passage 16 in a state that a differential pressure of “2α” is generated between the inlet 16a and the outlet 16b. Therefore, ink stored in the ink cartridge 3 is circulated through the supply flow passage 4, the tube pump 6, the supply flow passage 4, the pressurization bellows unit 8, the supply flow passage 4, the pressurization regulator 10, the supply flow passage 4, the common ink flow passage 16 of the inkjet head 2, the return flow passage 5, the passive regulator 32, the return flow passage 5, the tube pump 7, the return flow passage 5 and the ink cartridge 3.

As described above, according to the ink circulation system 41 in accordance with the fourth embodiment, the following operation-effects are obtained in addition to the operation-effects of the above-mentioned ink circulation systems. In other words, according to the ink circulation system 41 in accordance with the fourth embodiment, a pressure of the center value “−α” of the designated head value is generated in the outlet 16b by the pressure loss of the ink due to driving of the tube pump 7 and thus the cost of the system can be reduced while the ink is circulated appropriately.

### Fifth Embodiment

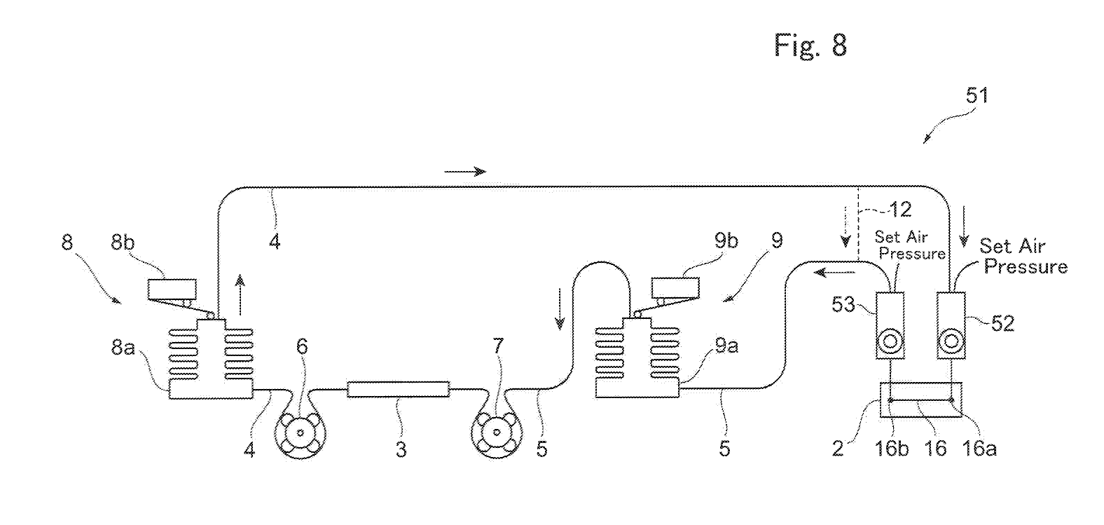

Next, an ink circulation system in accordance with a fifth embodiment will be described below with reference to FIG. 8. FIG. 8 is a schematic structure view showing an ink circulation system in accordance with the fifth embodiment of the present invention. As shown in FIG. 8, an ink circulation system 51 in accordance with the fifth embodiment includes an inkjet head 2, an ink cartridge 3, a supply flow passage 4, a return flow passage 5, a tube pump 6, a tube pump 7, a pressurization bellows unit 8, a pressure reduction bellows unit 9, a pilot air type pressurization regulator 52, a pilot air type pressure reducing regulator 53, and a high speed circulating flow passage 12.

In other words, in the ink circulation system 51, the pressurization regulator of the ink circulation system 1 in accordance with the first embodiment is replaced with the pilot air type pressurization regulator 52 and the pressure reducing regulator 11 is replaced with the pilot air type pressure reducing regulator 53.

The pilot air type pressurization regulator 52 is disposed between the pressurization bellows unit 8 and the inkjet head 2 and maintains the inlet 16a of the common ink flow passage 16 at a pressure not less than a predetermined pressure.

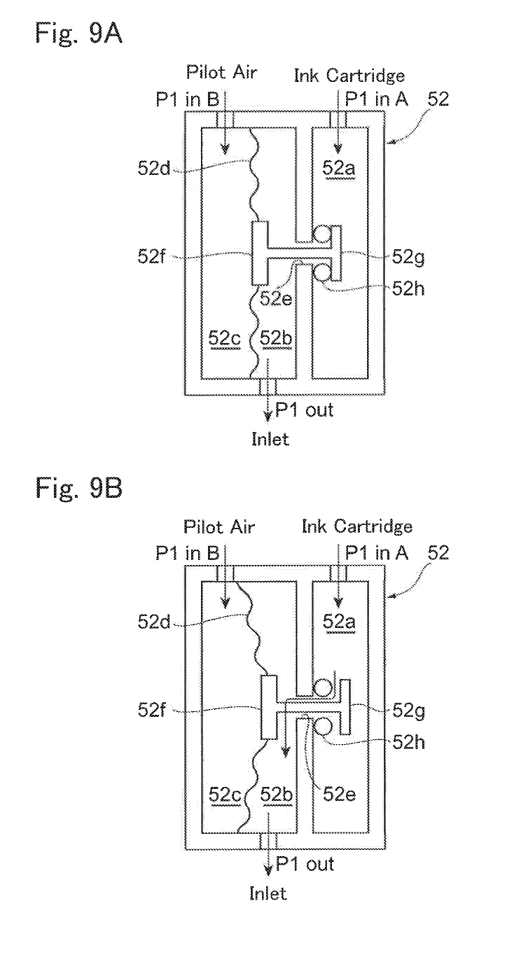

FIG. 9A and FIG. 9B are views showing a model of a pilot air type pressurization regulator. FIG. 9A shows a state that a valve is closed and FIG. 9B shows a state that the valve is opened. As shown in FIGS. 9A and 9B, the pilot air type pressurization regulator 52 is formed with a first pressure chamber 52a into which ink supplied from the ink cartridge 3 is flowed, a second pressure chamber 52b from which ink is flowed out to an inlet 16a of the common ink flow passage 16, and a third pressure chamber 52c into which pilot air having a set air pressure is flowed. The second pressure chamber 52b and the third pressure chamber 52c are partitioned by a diaphragm 52d and a through hole 52e is formed between the first pressure chamber 52a and the second pressure chamber 52b so as to communicate with each other and so that ink is flowed from the first pressure chamber 52a to the second pressure chamber 52b. A valve element 52f for opening and closing the through hole 52e is inserted into the through hole 52e. One end of the valve element 52f is connected with the diaphragm 52d and is movably held by the diaphragm 52d and its other end is formed with a valve 52g for closing the through hole 52e from the first pressure chamber 52a side. The valve element 52f is formed in a length so that the valve 52g closes the through hole 52e when there is no pressure difference between the first pressure chamber 52a and the second pressure chamber 52b. In the first pressure chamber 52a, an O-ring 52h for sealing is attached at a position corresponding to the valve 52g. Further, the set air pressure of the pilot air which is flowed into the third pressure chamber 52c is adjustable by a pump (pressure source) not shown.

In this embodiment, a pressure of ink which is flowed into the first pressure chamber 52a is set to be “P1inA”, a pressure of ink which is outputted from the second pressure chamber 52b is set to be “P1out”, and a set air pressure of the pilot air which is flowed into the third pressure chamber 52c is set to be “P1inB”.

In the pilot air type pressurization regulator 52 structured as described above, when the pressure “P1inB” is lower than the pressure “P1out”, the diaphragm 52d is deformed in a direction to close the valve element 52f (left direction in FIGS. 9A and 9B). Further, when the pressure “P1inB” is higher than the pressure “P1out”, the diaphragm 52d is deformed in a direction to open the valve element 52f (right direction in FIGS. 9A and 93).

Therefore, as shown in FIG. 9A, when the pressure “P1out” becomes not less than the set air pressure “P1inB” of the pilot air (P1out≧P1inB), the through hole 52e is closed by the valve 52g through the movement of the valve element 52f due to deformation of the diaphragm 52d. As a result, the flow of the ink from the first pressure chamber 52a to the second pressure chamber 52b is shut off and supply of the ink to the inlet 16a is stopped.

On the other hand, as shown in FIG. 9B, when the pressure “P1out” becomes lower than the set air pressure “P1in3” of the pilot air (P1out<P1inB), the through hole 52e is opened by the movement of the valve element 52f due to deformation of the diaphragm 52d. As a result, ink is flowed into the second pressure chamber 52b from the first pressure chamber 52a and supply of the ink to the inlet 16a is started again.

In this case, in order to control the pressure “P1out” to be a constant pressure by opening and closing the valve 52g, the pressure “P1inA” is required to be not less than the pressure “P1out” and it is preferable that the pressure “P1inA” is set to be a sufficiently higher value than the pressure “P1out”.

Strictly, in the pilot air type pressurization regulator 52, a force obtained by multiplying a pressure of the pressure “P1inA” acting on the valve 52g by an area of the valve 52g is also occurred. However, since the area of the valve 52g is normally small, the force may be ignored.

As described above, when an open-and-close operation of the valve 52g is repeated in a state that the pressure “P1out” is not more than the pressure “P1inA”, the pressure “P1out” is maintained to be the set air pressure “P1inB” of the pilot air although some variation may be occurred.

In the pilot air type pressurization regulator 52 which is structured as described above, the set air pressure of the pilot air is set to be the center value “+α” of the designated head value. As a result, the pressure “P1out” of the ink which is outputted from the second pressure chamber 52b is maintained at the center value “−α” of the designated head value by an open-and-close operation of the valve 52g and thus the ink pressure of the inlet 16a which is communicated with the second pressure chamber 52b is also maintained at the center value “+α” of the designated head value.

In addition, the pilot air type pressurization regulator 52 is required to set the pressure “P1inA” of the ink flowing into the first pressure chamber 52a to be not less than the pressure “P1out” of the ink outputted from the second pressure chamber 52b and thus a pressure generated by the pressurization bellows unit 8 is, for example, set to be in a range from 5000 to 20000 Pa. Therefore, the pressure “P1inA” of the ink which is flowed into the first pressure chamber 52a becomes in a range from 5000 to 20000 Pa.

As described above, in the pressurization bellows unit 8, a pressure applied to the ink is varied due to hysteresis of the ON/OFF switching of the micro switch 8b. However, in the pilot air type pressurization regulator 52, as long as the pressure “P1inA” of the ink flowed into the first pressure chamber 52a is not less than the pressure “P1out” of the ink outputted from the second pressure chamber 52b, the pressure “P1out” of the ink outputted from the second pressure chamber 52b is maintained at the center value “+u” of the designated head value. Therefore, even when pressure variation is occurred by the pressurization bellows unit 8, the pressure of the inlet 16a is maintained at the center value “−α” of the designated head value.

The pilot air type pressure reducing regulator 53 is disposed between the inkjet head 2 and the pressure reduction bellows unit 9 and maintains the outlet 16b of the common ink flow passage 16 at a pressure not more than a predetermined pressure.

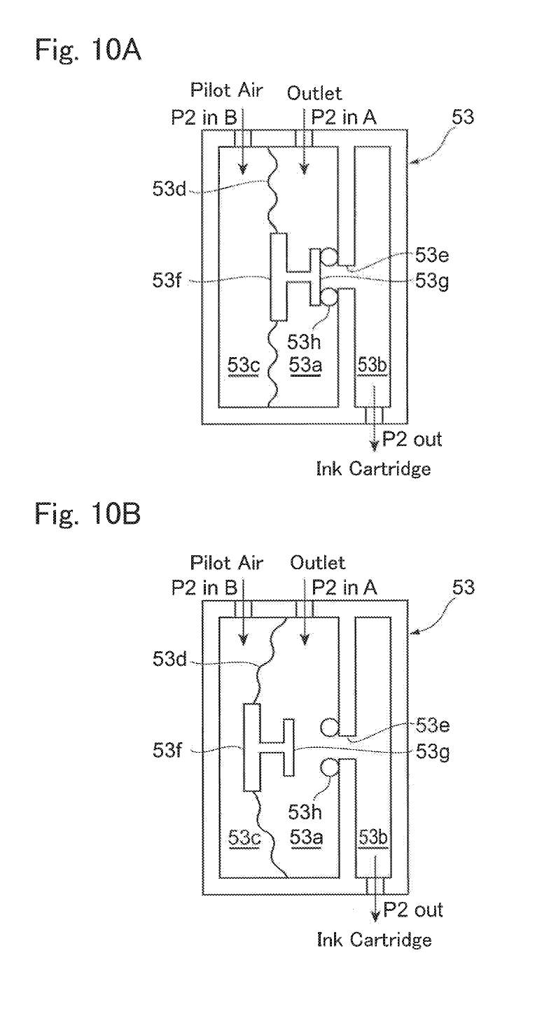

FIG. 10A and FIG. 10B are views showing a model of a pilot air type pressure reducing regulator. FIG. 10A shows a state that a valve is closed and FIG. 10B shows a state that the valve is opened. As shown in FIGS. 10A and 10B, the pilot air type pressure reducing regulator 53 is formed with a first pressure chamber 53a into which ink is flowed from the outlet 16b of the common ink flow passage 16, a second pressure chamber 53b from which ink is flowed out to the ink cartridge 3, and a third pressure chamber 53c into which pilot air having a set air pressure is flowed. The first pressure chamber 53a and the third pressure chamber 53c are partitioned by a diaphragm 53d. Further, in the pilot air type pressure reducing regulator 53, a through hole 53e is formed between the first pressure chamber 53a and the second pressure chamber 53b so as to communicate with each other and so that ink is flowed from the first pressure chamber 53a to the second pressure chamber 53b. A valve element 53f is provided for opening and closing the through hole 53e. One end of the valve element 53f is connected with the diaphragm 53d and is movably held by the diaphragm 53d and its other end is formed with a valve 53g for closing the through hole 53e from the first pressure chamber 53a side. The valve element 53f is formed in a length so that the valve 53g closes the through hole 53e when there is no pressure difference between the first pressure chamber 53a and the third pressure chamber 53c. In the first pressure chamber 53a, an O-ring 53h for sealing is attached at a position corresponding to the valve 53g. Further, a set air pressure of the pilot air which is flowed into the third pressure chamber 53c is adjustable by a pump (pressure source) not shown.

In this embodiment, a pressure of ink which is flowed into the first pressure chamber 53a is set to be “P2inA”, a pressure of ink which is outputted from the second pressure chamber 53b is set to be “P2out”, and a set air pressure of the pilot air which is flowed into the third pressure chamber 53c is set to be “P2inB”. In the pilot air type pressure reducing regulator 55 which is structured as described above, when the pressure “P2inB” is higher than the pressure “P2inA”, the diaphragm 53d is deformed in a direction to close the valve element 53f (right direction in FIGS. 10A and 10B). Further, when the pressure “P2inB” is lower than the pressure “P2inA”, the diaphragm 53d is deformed in a direction to open the valve element 53f (left direction in FIGS. 10A and 10B).

Therefore, as shown in FIG. 10A, when the pressure “P2inA” becomes not more than the set air pressure “P2inB” of the pilot air (P2inA $ P2inB), the through hole 53e is closed by the valve 53g through the movement of the valve element 53f due to deformation of the diaphragm 53d. As a result, the flow of the ink from the first pressure chamber 53a to the second pressure chamber 53b is shut off and discharge of the ink from the outlet 6b is stopped.

On the other hand, as shown in FIG. 10B, when the pressure “P2inA” becomes higher than the set air pressure “P2inB” of the pilot air (P2inA>P2inB), the through hole 53e is opened by the movement of the valve element 53f due to deformation of the diaphragm 53d. As a result, ink is flowed into the second pressure chamber 53b from the first pressure chamber 53a and discharge of the ink from the outlet 16b is started again.

In this case, in order to control the pressure “P2inA” to be a constant pressure by opening and closing the valve 53g, the pressure “P2out” is required to be not more than the pressure “P2inA” and it is preferable that the pressure “P2out” is set to be a sufficiently lower value than the pressure “P2inA”.

Strictly, in the pilot air type pressure reducing regulator 53, a force obtained by multiplying a pressure of the pressure “P2out” acting on the valve 53g by an area of the valve 53g is also occurred. However, since the area of the valve 53g is normally small, the force may be ignored.

As described above, when an open-and-close operation of the valve 53g is repeated in a state that the pressure “P2out” is not more than the pressure “P2inA”, the pressure “P2inA” is maintained to be the set air pressure “P2inB” of the pilot air although some variation may be occurred.

In the pilot air type pressure reducing regulator 53 which is structured as described above, the set air pressure of the pilot air is set to be the center value “−α” of the designated head value. As a result, the pressure “P2inA” of the ink which is flowed into the first pressure chamber 53a is maintained at the center value “−α” of the designated head value by an open-and-close operation of the valve 53g and thus the ink pressure of the outlet 16b which is communicated with the first pressure chamber 53a is also maintained at the center value “−α” of the designated head value.

In addition, the pilot air type pressure reducing regulator 53 is required to set the pressure “P2out” of the ink flowing out from the second pressure chamber 53b to be not more than the pressure “P2inA” of the ink flowing into the first pressure chamber 53a and thus a pressure generated by the pressure reduction bellows unit 9 is, for example, set to be in a range from −5000 to −20000 Pa. Therefore, the pressure “P2out” of the ink which is flowed out from the second pressure chamber 53b becomes in a range from −5000 to −20000 Pa.

As described above, in the pressure reduction bellows unit 9, a pressure applied to the ink is varied due to hysteresis of the ON/OFF switching of the micro switch 9b. However, in the pilot air type pressure reducing regulator 53, as long as the pressure “P2out” of the ink flowed out from the second pressure chamber 53b is not more than the pressure “P2inA” of the ink flowing into the first pressure chamber 53a, the pressure “P2inA” of the ink flowing into the first pressure chamber 53a is maintained at the center value “−α” of the designated head value. Therefore, even when pressure variation is occurred by the pressure reduction bellows unit 9, the pressure of the outlet 16b is maintained at the center value “−α” of the designated head value.

Next, an operation of the ink circulation system 51 will be described below. A high-speed circulating operation is basically similar to the first embodiment and thus only a normal circulating operation will be described below.

The normal circulating operation is performed by driving the tube pump 6, the tube pump 7, the micro switch 8b of the pressurization bellows unit 8, and the micro switch 9b of the pressure reduction bellows unit 9 through a control section not shown. In the normal circulating operation, the high speed circulating flow passage 12 is closed.

In the normal circulating operation, the ink in the supply flow passage 4 is sent toward the inkjet head 2 by the tube pump 6. Further, the ink which is sent out by the tube pump 6 is pressurized, for example, in a range from 5000 to 20000 Pa by the pressurization bellows unit 8. Therefore, the ink which is filled in the ink cartridge 3 is pressure-fed toward the inlet 16a and the ink on the inlet 16a side of the inkjet head 2 in the supply flow passage 4 is pressurized, for example, in a range from 5000 to 20000 Pa.

In this case, in the pilot air type pressurization regulator 52, pilot air adjusted at the set pressure of the center value “+α” of the designated head, value is flowed into the third pressure chamber 52c and the ink which is pressure-fed by the tube pump 6 and the pressurization bellows unit 8 is flowed into the first pressure chamber 52a. Then, when the pressure “P1out” of the ink which is flowed out from the second pressure chamber 52b to the inlet 16a becomes not more than the set air pressure “P1inB” of the pilot air, the valve 52g opens the through hole 52e. As a result, the ink flowed into the first pressure chamber 52a is flowed out from the second pressure chamber 52b and supply of the ink to the inlet 16a is performed. On the other hand, the pressure “P1out” of the ink which is flowed out from the second pressure chamber 52b to the inlet 16a becomes higher than the set air pressure “P1inB” of the pilot air, the valve 52g closes the through hole 52e. As a result, flow of the ink from the first pressure chamber 52a to the second pressure chamber 52b is shut off and the supply of the ink to the inlet 16a is stopped. As described above, the valve 52g is opened and closed based on the relationship between the pressure “P1out” of the ink flowing to the inlet 16a from the second pressure chamber 52b and the set air pressure “P1inB” of the pilot air and thereby the ink which is pressure-fed by the tube pump 6 and the pressurization bellows unit 8 is maintained at the center value “−α” of the designated head Value which is the set air pressure of the pilot air type pressurization regulator 52 and the ink is supplied to the inlet 16a.

On the other hand, the ink in the return flow passage 5 is sent out toward the ink cartridge 3 by the tube pump 7 and the pressure on the outlet 16b side of the inkjet head 2 in the return flow passage 5 is depressurized, for example, in the range from −5000 to −20000 Pa by the pressure reduction bellows unit 9.

In this case, in the pilot air type pressure reducing regulator 53, pilot air adjusted at the set pressure of the center value “−α” of the designated head value is flowed into the third pressure chamber 53c and ink is sucked from the second pressure chamber 53b by the tube pump 7 and the pressure reduction bellows unit 9. Then, when the pressure “P2inA” of the ink which is flowed into the first pressure chamber 53a from the outlet 16b becomes higher than the set air pressure “P2inB” of the pilot air, the valve 53g opens the through hole 53e. Therefore, the ink discharged from the outlet 1G6b is flowed into the second pressure chamber 53b through the first pressure chamber 53a and is sent out by the tube pump 7 and the pressure reduction bellows unit 9. On the other hand, when the pressure “P2inA” of the ink which is flowed into the first pressure chamber 53a from the outlet 16b becomes lower than the center value “−α” of the designated head value, the valve 53g closes the through hole 53e. Therefore, the flow of the ink from the first pressure chamber 53a to the second pressure chamber 53b is shut off and the discharge of the ink from the outlet 16b is stopped. As described above, the valve 53g is opened and closed based on the relationship between the pressure “P2inA” of the ink flowing to the first pressure chamber 53a from the outlet 16b and the set air pressure “P2inB” of the pilot air and thereby the ink returned from the outlet 16b is maintained at the center value “−α” of the designated head value which is the set pressure.

Therefore, ink is flowed through the common ink flow passage 16 from the inlet 16a to the outlet 16b by the differential pressure of “2α” which is generated between the inlet 16a and the outlet 16b. In this manner, the ink stored in the ink cartridge 3 is circulated through the supply flow passage 4, the tube pump 6, the supply flow passage 4, the pressurization bellows unit 8, the supply flow passage 4, the pilot air type pressurization regulator 52, the supply flow passage 4, the common ink flow passage 16 of the inkjet head 2, the return flow passage 5, the pilot air type pressure reducing regulator 53, the return flow passage 5, the pressure reduction bellows unit 9, the return flow passage 5, the tube pump 7, the return flow passage 5 and the ink cartridge 3.

As described above, according to the ink circulation system 51 in accordance with the fifth embodiment, the following operation-effects are obtained in addition to the operation effects of the above-mentioned ink circulation systems in other words, according to the ink circulation system 51 in accordance with the fifth embodiment, in the pilot air type pressurization regulator 52, supply and stop of ink is switched based on the pressure difference between the ink pressure which is flowed into the inlet 16a from the second pressure chamber 52b and the air pressure of the pilot air which is flowed into the third pressure chamber 52c. Therefore, the ink pressure of the inlet 16a can be easily changed by changing the set air pressure of the pilot air and thus the degree of freedom of the set pressure is remarkably improved and, even when a plurality of the pressurization regulators is used, the set pressure can be changed simultaneously.

Further, in the pilot air type pressurization regulator 52, when the ink pressure discharged from the second pressure chamber 52b becomes higher than the pressure of the pilot air which is flowed into the third pressure chamber 52c, the valve element 52f closes the through hole 52e to stop the supply of the ink and, when the ink pressure discharged from the second pressure chamber 52b becomes lower than the pressure of the pilot air which is flowed into the third pressure chamber 52c, the valve element 52f opens the through hole 52e and the supply of the ink is started again. Therefore, passing and stop of the ink can be mechanically performed by setting the pressure of the pilot air which is flowed into the third pressure chamber 52c without performing complicated control and thus the ink pressure of the inlet 16a in the common ink flow passage 16 can be further surely maintained at the set pressure.

Further, in the pilot air type pressure reducing regulator 53, supply and stop of ink is switched based on the pressure difference between the ink pressure which is flowed into the first pressure chamber 53a from the outlet 16b and the air pressure of the pilot air which is flowed into the third pressure chamber 53c. Therefore, the ink pressure of the outlet 16b can be easily changed by changing the set air pressure of the pilot air and thus the degree of freedom of the set pressure is remarkably improved and, even when a plurality of the pressure reducing regulators is used, the set pressure can be changed simultaneously.

Further, in the pilot air type pressure reducing regulator 53, when the ink pressure which is flowed into the first pressure chamber 53a becomes lower than the pressure of the pilot air which is flowed into the third pressure chamber 53c, the valve element 53f closes the through hole 53e and the supply of the ink is stopped and, when the ink pressure flowed into the first pressure chamber 53a becomes higher than the pressure of the pilot air which is flowed into the third pressure chamber 53c, the valve element 53f opens the through hole 53e and the supply of the ink is started again. Therefore, passing and stop of the ink can be mechanically performed by only setting the pressure of the pilot air which is flowed into the third pressure chamber 53c without performing complicated control and thus the ink pressure of the outlet 16b in the common ink flow passage 16 can be further surely maintained at the set pressure.

Although the present invention has been shown and described with reference to a specific embodiment, various changes and modifications will be apparent to those skilled in the art from the teachings herein. For example, in the embodiments described above, as a means structured to pressurize and supply the ink from the ink cartridge 3 to the inkjet head 2, (1) the tube pump 6 and the pressurization bellows unit 8 or, (2) differential pressure generating pump 22 is adopted, as a supply pressure setting means to the inlet 16a, (1) the pressurization regulator 10 or, (2) the pilot air type pressurization regulator 52 is adopted, as a return pressure setting means from the outlet 16b, (1) the pressure reducing regulator 11, (2) the arrangement relationship of the inkjet head 2 and the ink cartridge 3, (3) the pressure loss control by the tube pump 7 or, (4) the pilot air type pressure reducing regulator 53 is adopted and, as a means structured to depressurize and return the ink from the inkjet head 2 to the ink cartridge 3, (1) the tube pump 7 and the pressure reduction bellows unit 9, (2) the differential pressure generating pump 22, (3) the arrangement relationship of the inkjet head 2 and the ink cartridge 3 or, (4) the pressure loss control by the tube pump 7 is adopted. However, combination of these means can be changed appropriately and the respective means can be structured of another structural means.

Further, in the embodiments described above, an ink circulation system which is mounted on an inkjet printer is described as an example of the present invention. However, the present invention may be applied to a liquid circulation system mounted on an industrial droplet ejection device and the like in which, for example, high viscosity liquid such as edible oil or an adhesive is ejected as a droplet.

1. A liquid circulation system which is mounted on a droplet ejection device from which droplets are ejected, comprising:
a droplet ejection head which is formed with a common flow passage communicated with a plurality of nozzles from which the droplets are ejected;
a liquid filling container which is filled with liquid that is supplied to the droplet ejection head;
a first flow passage through which the liquid is supplied from the liquid filling container to one end part of the common flow passage;
a second flow passage through which the liquid is returned fromrn an other end part of the common flow passage to the liquid filling container;
a differential pressure generating means structured to pressurize the liquid on one end part side in the common flow passage and depressurize the liquid on an other end part side in the common flow passage; and
a pressurization regulator which is disposed between the differential pressure generating means and the one end part of the common flow passage and is structured to maintain the liquid at the one end part in the common flow passage at a first pressure.

2. The liquid circulation system according to claim 1, wherein the pressurization regulator shuts off flow of the liquid when a liquid pressure at the one end part in the common flow passage becomes higher than the first pressure and flows the liquid when the liquid pressure at the one end part in the common flow passage becomes lower than the first pressure.

3. The liquid circulation system according to claim 1, further comprising a pressure reducing regulator which is disposed between the differential pressure generating means and the other end part of the common flow passage and is structured to maintain the liquid at the other end part in the common flow passage at a second pressure that is lower than the first pressure.

4. The liquid circulation system according to claim 4, wherein the pressure reducing regulator shuts off flow of the liquid when liquid pressure at the other end part in the common flow passage becomes lower than the second pressure and flows the liquid when the liquid pressure at the other end part in the common flow passage becomes higher than the second pressure.

5. The liquid circulation system according to claim 2, wherein the pressurization regulator comprises:
a first pressure chamber into which the liquid is flowed, from the liquid filling container through a pressurization side of a differential pressure generating part;
a second pressure chamber which is formed with a through hole communicated with the first pressure chamber and from which the liquid is sent to the one end part of the common flow passage;
a diaphragm which separates the second pressure chamber from ambient atmosphere;
a valve element which is connected with the diaphragm for opening and closing the through hole; and
a pressure control spring which urges the valve element in a direction for closing the through hole.

6. The liquid circulation system according to claim 2, wherein
air which is adjusted at a predetermined pressure is introduced into the pressurization regulator, and
the pressurization regulator opens and closes a liquid flow passage based on comparison of a pressure of the air with a liquid pressure which is discharged to the one end part of the common flow passage.

7. The liquid circulation system according to claim 6, wherein the pressurization regulator comprises:
a first pressure chamber into which the liquid is flowed from the liquid filling container;
a second pressure chamber which is formed with a through hole communicated with the first pressure chamber and from which the liquid is discharged to the one end part of the common flow passage;
a third pressure chamber into which air at a predetermined pressure is flowed;
a diaphragm which separates the second pressure chamber from the third pressure chamber; and
a valve element which is connected with the diaphragm for opening and closing the through hole.

8. The liquid circulation system according to claim 4, wherein the pressure reducing regulator comprises:
a first pressure chamber into which the liquid returned from the other end part of the common flow passage is flowed;
a second pressure chamber which is formed with a through hole communicated with the first pressure chamber and from which the liquid is discharged to a flow passage communicated with a negative pressure side of the differential pressure generating part;
a diaphragm which separates the first pressure chamber from ambient atmosphere;
a valve element which is connected with the diaphragm for opening and closing the through hole; and
a pressure control spring which urges the valve element in a direction for opening the through hole.

9. The liquid circulation system according to claim 4, wherein
air which is adjusted at a predetermined pressure is introduced into the pressure reducing regulator, and
the pressure reducing regulator opens and closes a liquid flow passage based on comparison of a pressure of the air with a liquid pressure which is flowed from the other end part of the common flow passage.

10. The liquid circulation system according to claim 9, wherein the pressure reducing regulator comprises:
a first pressure chamber into which the liquid is flowed from the other end part of the common flow passage;
a second pressure chamber which is formed with a through hole communicated with the first pressure chamber and from which the liquid is discharged to the liquid filling container;
a third pressure chamber into which air at a predetermined pressure is flowed;
a diaphragm which separates the second pressure chamber from the third pressure chamber; and
a valve element which is connected with the diaphragm for opening and closing the through hole.

11. The liquid circulation system according to claim 3 or 4, wherein
the first pressure and the second pressure are set to be within a range of a designated water head of the droplet ejection head,
the first pressure is a pressure higher by a predetermined pressure than a center value of a designated head value of the droplet ejection head, and
the second pressure is a pressure lower by the predetermined pressure than the center value of the designated head value.

12. The liquid circulation system according to claim 1, wherein
the differential pressure generating means pressurizes the liquid on the one end part side in the common flow passage by a pressurization bellows for pressurizing the liquid and a first tube pump for sending the liquid to a liquid droplet ejection head side, and
the differential pressure generating means depressurizes the liquid on the other end part side in the common flow passage by a pressure reduction bellows for depressurizing the liquid and a second tube pump for sending the liquid to a liquid filling container side.

13. The liquid circulation system according to claim 1, wherein the differential pressure generating means comprises a differential pressure generating pump which is provided in the first flow passage or the second flow passage for generating a differential pressure.

14. The liquid circulation system according to claim 1 or 2, wherein
the differential pressure generating means pressurizes the liquid on the one end part side in the common flow passage by a pressurization bellows for pressurizing the liquid and a first tube pump for sending the liquid to a droplet ejection head side, and
a height difference is provided between the droplet ejection head and the liquid filling container so that a liquid pressure at the other end part in the common flow passage is lower than a liquid pressure at the one end part in the common flow passage.
